(19) United States
(12) Patent Application Publication
(10) Pub. No.: US 2015/0294585 A1
(43) Pub. Date: Oct. 15, 2015

(54) NEUROPERFORMANCE

(71) Applicant: ASPEN PERFORMANCE TECHNOLOGIES, Tel Aviv (IL)

(72) Inventors: Jose Roberto KULLOK, Efrat (IL); Saul KULLOK, Efrat (IL)

(21) Appl. No.: 14/468,951

(22) Filed: Aug. 26, 2014

Related U.S. Application Data
(63) Continuation-in-part of application No. 14/251,116, filed on Apr. 11, 2014.
Application No. 14/251,116 is a continuation-in-part of application No. 14/251,163, filed on Apr. 11, 2014.
Application No. 14/251,163 is a continuation-in-part of application No. 14/251,007, filed on Apr. 11, 2014.
Application No. 14/251,007 is a continuation-in-part of application No. 14/251,034, filed on Apr. 11, 2014.
Application No. 14/251,034 is a continuation-in-part of application No. 14/251,041, filed on Apr. 11, 2014.

(51) Int. Cl. G09B 19/00; G09B 5/02

(52) U.S. Cl. CPC G09B 19/00; G09B 5/02

(57) ABSTRACT

Methods of promoting fluid intelligence abilities in a subject including the steps of: selecting one or more serial orders of open-bigram terms from a predefined library of complete open-bigram sequences, providing the subject with a further selected one or more incomplete serial orders of different open-bigram terms from the selected one or more serial orders; prompting the subject to sensorially discriminate and sensory motor insert one or more missing open-bigram terms in the one or more incomplete serial orders of open-bigram terms to form one or more completed alphabetical serial orders of open-bigram terms; determining whether the subject correctly sensorially discriminated and sensory motor inserted the open-bigram terms; and displaying the correct sensorially discriminated and sensory motor inserted open-bigram terms with at least one different spatial and/or time perceptual related attribute to highlight the correct open-bigram term answers.

This is a Continuation-In-Part of U.S. patent application Ser. No. 14/251,116, U.S. patent application Ser. No. 14/251,163, U.S. patent application Ser. No. 14/251,007, U.S. patent application Ser. No. 14/251,034, and U.S. patent application Ser. No. 14/251,041, all filed on Apr. 11, 2014, the disclosure of each which is hereby incorporated by reference.

### FIELD

The present disclosure relates to a system, method, software, and tools employing a novel disruptive non-pharmacological technology that prompts correlation of a subject's sensory-motor-perceptual-cognitive activities with novel constrained sequential statistical and combinatorial properties of alphanumerical series of symbols (e.g., in alphabetical series, letter sequences and series of numbers). These statistical and combinatorial properties determine alphanumeric sequential relationships by establishing novel interrelations, correlations and cross-correlations among the sequence terms. The new interrelations, correlations and cross-correlations among the sequence terms prompted by this novel non-pharmacological technology sustain and promote neural plasticity in general and neural-linguistic plasticity in particular. This technology is carried out through new strategies implemented by exercises particularly designed to amplify these novel sequential alphanumeric interrelations, correlations and cross-correlations. More importantly, this non-pharmacological technology entwines and grounds sensory-motor-perceptual-cognitive activity to statistical and combinatorial information constraining serial orders of alphanumeric symbols sequences. As a result, the problem solving of the disclosed body of alphanumeric series exercises is hardly cognitively taxing and is mainly conducted via fluid intelligence abilities (e.g., inductive-deductive reasoning, novel problem solving, and spatial orienting).

A primary goal of the non-pharmacological technology disclosed herein is maintaining stable cognitive abilities, delaying, and/or preventing cognitive decline in a subject experiencing normal aging. Likewise, this goal includes restraining working and episodic memory and cognitive impairments in a subject experiencing mild cognitive decline associated, e.g., with mild cognitive impairment (MCI) or pre-dementia and delaying the progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology is beneficial as a training cognitive intervention designated to improve the instrumental performance of an elderly person in daily demanding functioning tasks by enabling some transfer from fluid cognitive trained abilities to everyday functioning. Further, this non-pharmacological technology is also beneficial as a brain fitness training/cognitive learning enhancer tool for the normal aging population, a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential, combinatorial and statistical properties of the serial orders of its symbols (e.g., in the letters series of a language alphabet and in a series of numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-linguistic plasticity, thus preventing or decelerating the chemical break-down initiation of the biological neural machine as it grows old.

The present non-pharmacological technology accomplishes this by principally focusing on the root base component of language, its alphabet, organizing its constituent parts, namely its letters and letter sequences (chunks) in novel ways to create rich and increasingly new complex non-semantic (serial non-word chunks) networking. This technology explicitly reveals the most basic minimal semantic textual structures in a given language (e.g., English) and creates a novel alphanumeric platform by which these minimal semantic textual structures can be exercised within the given language alphabet. The present non-pharmacological technology also accomplishes this by focusing on the natural numbers numerical series, organizing its constituent parts, namely its single number digits and number sets (numerical chunks) in novel serial ways to create rich and increasingly new number serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition). Furthermore, the present non-pharmacological technology also derives its effectiveness by promoting efficient processing speed of phonological and visual pattern information among alphabetical serial structures (e.g., letters and letter patterns and their statistical and combinatorial properties, including non-word letter patterns), thereby promoting neuronal plasticity in general across several distant brain regions and hemispheric related language neural plasticity in particular.

The advantage of the non-pharmacological cognitive intervention technology disclosed herein is that it is effective, safe, and user-friendly, demands low arousal thus low attentional effort, is non-invasive, has no side effects, is non-addictive, scalable, and addresses large target markets where currently either no solution is available or where the solutions are partial at best.

### BRIEF DESCRIPTION OF DRAWINGS

FIG. 1 is a flow chart setting forth the method that the present exercises use in promoting fluid intelligence abilities in a subject by reasoning strategies the subject utilizes in order to correctly sensorially discriminate and sensory motor insert missing open-bigram terms into an incomplete serial order of open-bigram terms to form a completed serial order of open-bigram terms.

FIGS. 2A-2D depict a number of non-limiting examples for sensorial discrimination and sensory motor inserting the correct missing open-bigram terms in an incomplete serial order of open-bigram terms. FIG. 2A shows an incomplete direct alphabetical serial order of open-bigram terms, along with the complete alphabetical serial order of open-bigram terms underneath the incomplete serial order of open-bigram terms. FIG. 2B shows the completed alphabetical serial order of open-bigram terms with the correct sensorially discriminated and sensory motor inserted open-bigram terms displayed with a changed time perceptual related attribute in the form of a font color change. FIG. 2C shows an incomplete inverse alphabetical serial order of open-bigram terms along with the complete inverse alphabetical serial order of open-bigram terms there under. FIG. 2D shows the correct sensorially discriminated and sensory motor inserted open-bigram terms having a single changed spatial perceptual related attribute in the form of font boldness.

FIG. 3 is a flow chart setting forth the method that the present exercises use in promoting fluid intelligence abilities in a subject by completing a predefined incomplete serial order of open-bigram terms with two or more incomplete serial orders of open-bigram terms to form a completed serial order of open-bigram (e.g., alphabetic, numeric or alphanumeric symbols) terms.

FIGS. 4A-4C depict a non-limiting example of the exercises completing an incomplete serial order of open-bigram terms to obtain a complete serial order of open-bigram terms. FIG. 4A shows an original incomplete alphabetical serial order of open-bigram terms along with a number of other incomplete serial orders of open-bigram terms provided thereunder. FIG. 4B shows that the subject has correctly sensorially identified and sensory motor selected one complementary contiguous incomplete serial order of open-bigram terms AB CD EF GH. Further, FIG. 4C shows the obtained completed direct alphabetical serial order of open-bigram terms with the subject having correctly sensorially identified and sensory motor selected the second complementary contiguous incomplete serial order of open-bigram terms ST UV WX YZ.

### DETAILED DESCRIPTION

### Introduction

It is generally assumed that individual letters and the mechanism responsible for coding the positions of these letters in a string are the key elements for orthographic processing and determining the nature of the orthographic code. To expand the understanding of the mechanisms that interact, inhibit and modulate orthographic processing, there should also be an acknowledgement of the ubiquitous influence of phonology in reading comprehension. There is a growing consensus that reading involves multiple processing routes, namely the lexical and sub-lexical routes. In the lexical route, a string directly accesses lexical representations. When a visual image first arrives at a subject's cortex, it is in the form of a retinotopic encoding. If the visual stimulus is a letter string, an encoding of the constituent letter identities and positions takes place to provide a suitable representation for lexical access. In the sub-lexical route, a string is transformed into a phonological representation, which then contacts lexical representations.

Indeed, there is growing consensus that orthographic processing must connect with phonological processing quite early on during the process of visual word recognition, and that phonological representations constrain orthographic processing (Frost, R. (1998) Toward a strong phonological theory of visual word recognition: True issues and false trails, Psychological Bulletin, 123, 71_{—}99; Van Orden, G. C. (1987) A ROWS is a ROSE: Spelling, sound, and reading, Memory and Cognition, 15(3), 181-1987; and Ziegler, J. C., & Jacobs, A. M. (1995), Phonological information provides early sources of constraint in the processing of letter strings, Journal of Memory and Language, 34, 567-593).

Another major step forward in orthographic processing research concerning visual word recognition has taken into consideration the anatomical constraints of the brain to its function. Hunter and Brysbaert describe this anatomical constraint in terms of interhemispheric transfer cost (Hunter, Z. R., & Brysbaert, M. (2008), Theoretical analysis of interhemispheric transfer costs in visual word recognition, Language and Cognitive Processes, 23, 165-182). The assumption is that information falling to the right and left of fixation, even within the fovea, is sent to area V1 in the contralateral hemisphere. This implies that information to the left of fixation (LVF), which is processed initially by the right hemisphere of the brain, must be redirected to the left hemisphere (collosal transfer) in order for word recognition to proceed intact.

Still, another general constraint to orthographic processing is the fact that written words are perceived as visual objects before attaining the status of linguistic objects. Research has revealed that there seems to be a pre-emption of visual object processing mechanisms during the process of learning to read (McCandliss, B., Cohen, L., & Dehaene, S. (2003), The visual word form area: Expertise for reading in the fusiform gyrus, Trends in Cognitive Sciences, 13, 293-299). For example, the alphabetic array proposed by Grainger and van Heuven is one such mechanism, described as a specialized system developed specifically for the processing of strings of alphanumeric stimuli (but not for symbols) (Grainger, J., & van Heuven, W. (2003), Modeling letter position coding in printed word perception, In P. Bonin (Ed.), The mental lexicon (pp. 1-23), New York: Nova Science).

### Transposed Letter (TL) Priming

The effects of letter order on visual word recognition have a long research history. Early on during word recognition, letter positions are not accurately coded. Evidence of this comes from transposed-letter (TL) priming effects, in which letter strings generated by transposing two adjacent letters (e.g., “jugde” instead of “judge”) produce large priming effects, more than the priming effect with the letters replaced by different letters in the corresponding position (e.g., “junpe” instead of “judge”). Yet, the clearest evidence for TL priming effects was obtained from experiments using non-word anagrams formed by transposing two letters in a real word (e.g., “mohter” instead of “mother”) and comparing performance with matched non-anagram non-words (Andrews, S. (1996), Lexical retrieval and selection processes: Effects of transposed letter confusability, Journal of Memory and Language, 35, 775-800; Bruner, J. S., & O'Dowd, D. (1958), A note on the informativeness of parts of words, Language and Speech, 1, 98-101; Chambers, S. M. (1979), Letter and order information in lexical access, Journal of Verbal Learning and Behavior, 18, 225-241; O'Connor, R. E., & Forster, K. I. (1981), Criterion bias and search sequence bias in word recognition, Memory and Cognition, 9, 78-92; and Perea, M., Rosa, E., & Gomez, C. (2005), The frequency effect for pseudowords in the lexical decision task, Perception and Psychophysics, 67, 301-314). These experiments show that TL non-word anagrams are more often misperceived as a real word or misclassified as a real word in a lexical decision task than the non-anagram controls.

Other experiments that focused on the role of letter order in the perceptual matching task in which subjects had to classify two strings of letters as being either the same or different exhibited a diversity of responses depending on the number of shared letters and the degree to which the shared letters match in ordinal position (Krueger, L. E. (1978), A theory of perceptual matching, Psychological Review, 85, 278-304; Proctor, R. W., & Healy, A. F. (1985), Order-relevant and order-irrelevant decision rules in multiletter matching, Journal of Experimental Psychology: Learning, Memory, and Cognition, 11, 519-537; and Ratcliff, R. (1981), A theory of order relations in perceptual matching, Psychological Review, 88, 552-572). Observed priming effects were ruled by the number of letters shared across prime and target and the degree of positional match. Still, Schoonbaert and Grainger found that the size of TL-priming effects might depend on word length, with larger priming effects for 7-letter words as compared with 5-letter words (Schoonbaert, S., & Grainger, J. (2004), Letter position coding in printed word perception: Effects of repeated and transposed letters, Language and Cognitive Processes, 19, 333-367). More so, Guerrera and Foster found robust TL-priming effects in 8-letter words with rather extreme TL operations involving three transpositions e.g., 13254768-12345678 (Guerrera, C., & Forster, K. I. (2008), Masked form priming with extreme transposition, Language and Cognitive Processes, 23, 117-142). In short, target word length and/or target neighborhood density strongly determines the size of TL-priming effects.

Of equal importance, TL priming effects can also be obtained with the transposition of non-adjacent letters. The robust effects of non-adjacent TL primes were reported by Perea and Lupker with 6-10 letter long Spanish words (Perea, M., & Lupker, S. J. (2004), Can CANISO activate CASINO? Transposed-letter similarity effects with nonadjacent letter positions, Journal of Memory and Language, 51(2), 231-246). Same TL primes effects were reported in English words by Lupker, Perea, and Davis (Lupker, S. J., Perea, M., & Davis, C. J. (2008), Transposed-letter effects: Consonants, vowels, and letter frequency, Language and Cognitive Processes, 23, (1), 93-116). Additionally, Guerrera and Foster have shown that priming effects can be obtained when primes include multiple adjacent transpositions e.g., 12436587-12345678 (Guerrera, C., & Forster, K. I. (2008), Masked form priming with extreme transposition, Language and Cognitive Processes, 23, 117-142).

Past research regarding a possible influence of letter position (inner versus outer letters) in TL priming has shown that non-words formed by transposing two inner letters are harder to respond to in a lexical decision task than non-words formed by transposing the two first or the two last letters (Chambers, S. M. (1979), Letter and order information in lexical access, Journal of Verbal Learning and Behavior, 18, 225-241). Still, Schoonbaert and Grainger provided evidence that TL primes involving an outer letter (the first or the last letter of a word) are less effective than TL primes involving two inner letters (Schoonbaert, S., & Grainger, J. (2004), Letter position coding in printed word perception: Effects of repeated and transposed letters, Language and Cognitive Processes, 19, 333-367). Guerrera and Foster also suggested a special role of a word's outer letters (Guerrera, C., & Forster, K. I. (2008), Masked form priming with extreme transposition, Language and Cognitive Processes, 23, 117-142; and Jordan, T. R., Thomas, S. M., Patching, G. R., & Scott-Brown, K. C. (2003), Assessing the importance of letter pairs in initial, exterior, and interior positions in reading, Journal of Experimental Psychology: Learning, Memory, and Cognition, 29, 883-893).

In all of the above-mentioned studies, the TL priming contained all of the target's letters. When primes do not contain the entire target's letters, TL priming effects diminish substantially and tend to vanish (Humphreys, G. W., Evett, L. J., & Quinlan, P. T. (1990), Orthographic processing in visual word identification, Cognitive Psychology, 22, 517-560; and Peressotti, F., & Grainger, J. (1999), The role of letter identity and letter position in orthographic priming, Perception and Psychophysics, 61, 691-706).

### Relative-Position (RP) Priming

Relative-position (RP) priming involves a change in length across the prime and target such that shared letters can have the same order without being matched in terms of absolute length-dependent positions. RP priming can be achieved by removing some of the target's letters to form the prime stimulus (subset priming) or by adding letters to the target (superset priming). Primes and targets differing in length are obtained so that absolute position information changes while the relative order of letters is preserved. For example, for a 5-letter target e.g., 12345, a 5-letter substitution prime such as 12d45 contains letters that have the same absolute position in the prime and the target, while a 4-letter subset prime such as 1245 contains letters that preserve their relative order in the prime and the target but not their precise length-dependent position. Humphreys et al. reported significant priming for primes sharing four out of five of the target's letters in the same relative position (1245) compared to both a TL prime condition (1435) and an outer-letter only condition 1 dd5 (Humphreys, G. W., Evett, L. J., & Quinlan, P. T. (1990), Orthographic processing in visual word identification, Cognitive Psychology, 22, 517-560).

Peressotti and Grainger provided further evidence for the effects of RL priming using the Foster and Davis masked priming technique. They reported that, with 6-letter target words, RP primes (1346) produced a significant priming effect compared with unrelated primes (dddd). Meanwhile, violation of the relative position of letters across the prime and the target e.g., 1436, 6341 cancelled priming effects relative to all different letter primes e.g., dddd (Peressotti, F., & Grainger, J. (1999), The role of letter identity and letter position in orthographic priming, Perception and Psychophysics, 61, 691-706). Grainger et al., reported small advantages for beginning-letter primes e.g., 1234/12345 compared with end-letter primes e.g., 4567/6789 (Grainger, J., Granier, J. P., Farioli, F., Van Assche, E., & van Heuven, W. (2006a), Letter position information and printed word perception: The relative-position priming constraint, Journal of Experimental Psychology: Human Perception and Performance, 32, 865-884). Likewise, an advantage for completely contiguous primes e.g., 1234/12345-34567/56789 is explained in terms of a phonological overlap in the contiguous condition compared with non-contiguous primes e.g., 1357/13457/1469/14569 (Frankish, C., & Turner, E. (2007), SIHGT and SUNOD: The role of orthography and phonology in the perception of transposed letter anagrams, Journal of Memory and Language, 56, 189-211). Further, Schoonbaert and Grainger utilize 7-letter target words containing a non-adjacent repeated letter such as “balance” and form prime stimuli “balnce” or “balace”. They reported priming effects were not influenced by the presence or absence of a letter repetition in the formed prime stimulus. On the other hand, performance to target stimuli independently of prime condition was adversely affected by the presence of a repeated letter, and this was true for both the word and non-word targets (Schoonbaert, S., & Grainger, J. (2004), Letter position coding in printed word perception: Effects of repeated and transposed letters, Language and Cognitive Processes, 19, 333-367).

### Letter Position Serial Encoding: The SERIOL Model

The SERIOL model (Sequential Encoding Regulated by Inputs to Oscillations within Letter units) is a theoretical framework that provides a comprehensive account of string processing in the proficient reader. It offers a computational theory of how a retinotopic representation is converted into an abstract representation of letter order. The model mainly focuses on bottom-up processing, but this is not meant to rule out top-down interactions.

The SERIOL model is comprised of five layers: 1) edges, 2) features, 3) letters, 4) open-bigrams, and 5) words. Each layer is comprised of processing units called nodes, which represent groups of neurons. The first two layers are retinotopic, while the latter three layers are abstract. For the retinotopic layers, the activation level denotes the total amount of neural activity across all nodes devoted to representing a letter within a given layer. A letter's activation level increases with the number of neurons representing that letter and their firing rate. For the abstract layers, the activation denotes the activity level of a representational letter unit in a given layer. In essence, the SERIOL model is the only one that specifies an abstract representation of individual letters. Such a letter unit can represent that letter in any retinal location, wherein timing firing binds positional information in the string to letter identity.

The edge layer models early visual cortical areas V1/V2. The edge layer is retinotopically organized and is split along the vertical meridian corresponding to the two cerebral hemispheres. In these early visual cortical areas, the rate of spatial sampling (acuity) is known to sharply decrease with increasing eccentricity. This is modelled by the assumption that activation level decreases as distance from fixation increases. This pattern is termed the ‘acuity gradient’. In short, the activation pattern at the lowest level of the model, the edge layer, corresponds to visual acuity.

The feature layer models V4. The feature layer is also retinotopically organized and split across the hemispheres. Based on learned hemisphere-specific processing, the acuity gradient of the edge layer is converted to a monotonically decreasing activation gradient (called the locational gradient) in the feature layer. The activation level is highest for the first letter and decreases across the string. Hemisphere-specific processing is necessary because the acuity gradient does not match the locational gradient in the first half of a fixated word (i.e., acuity increases from the first letter to the fixated letter and the locational gradient decreases across the string), whereas the acuity gradient and locational gradient match in the second half of the word (i.e., both decreasing). Strong directional lateral inhibition is required in the hemisphere (for left-to-right languages—Right Hemisphere [RH]) contralateral to the first half of the word (for left-to-right languages—Left Visual Field [LVF]), in order to invert the acuity gradient.

At the letter layer, corresponding to the posterior fusiform gyms, letter units fire serially due to the interaction of the activation gradient with oscillatory letter nodes (see above feature layer). That is, the letter unit encoding the first letter fires, then the unit encoding the second letter fires, etc. This mechanism is based on the general proposal that item order is encoded in successive gamma cycles 60 Hz of a theta cycle 5 Hz (Lisman, J. E., & Idiart, M. A. P. (1995), Storage of 7±2 short-term memories in oscillatory subcycles, Science, 267, 1512-1515). Lisman and Idiart have proposed related mechanisms for precisely controlling spike timing, in which nodes undergo synchronous, sub-threshold oscillations of excitability. The amount of input to these nodes then determines the timing of firing with respect to this oscillatory cycle. That is, each activated letter unit fires in a burst for about 15 ms (one gamma cycle), and bursting repeats every 200 ms (one theta cycle). Activated letter units burst slightly out of phase with each other, such that they fire in a rapid sequence. This firing rapid sequence encoding (seriality) is the key point of abstraction.

In the present SERIOL model, the retinotopic presentation is mapped onto a temporal representation (space is mapped onto time) to create an abstract, invariant representation that provides a location-invariant representation of letter order. This abstract serial encoding provides input to both the lexical and sub-lexical routes. It is assumed that the sub-lexical route parses and translates the sequence of letters into a grapho-phonological encoding (Whitney, C., & Comelissen, P. (2005), Letter-position encoding and dyslexia, Journal of Research in Reading, 28, 274-301). The resulting representation encodes syllabic structure and records which graphemes generated which phonemes. The remaining layers of the model address processing that is specific to the lexical route.

At the open-bigram layer, corresponding to the left middle fusiform, letter units recognize pairs of letter units that fire in a particular order (Grainger, J., & Whitney, C. (2004), Does the huamn mnid raed wrods as a whole?, Trends in Cognitive Sciences, 8, 58-59). For example, open-bigram unit XY is activated when letter unit X fires before Y, where the letters x and y were not necessarily contiguous in the string. The activation of an open-bigram unit decreases with increasing time between the firing of the constituent letter units. Thus, the activation of open-bigram XY is highest when triggered by contiguous letters, and decreases as the number of intervening letters increases. Priming data indicates that the maximum separation is likely to be two letters (Schoonbaert, S., & Grainger, J. (2004), Letter position coding in printed word perception: Effects of repeated and transposed letters, Language and Cognitive Processes, 19, 333-367). Open-bigram activations depend only on the distance between the constituent letters (Whitney, C. (2004a), Investigations into the neural basis of structured representations, Doctoral Dissertation. University of Maryland).

Still, following the evidence for a special role for external letters, the string is anchored to those endpoints via edge open-bigrams; whereby edge units explicitly encode the first and last letters (Humphreys, G. W., Evett, L. J., & Quinlan, P. T. (1990), Orthographic processing in visual word identification, Cognitive Psychology, 22, 517-560). For example, the encoding of the stimulus CART would be *C (open-bigram *C is activated when letter C is preceded by a space), CA, AR, CR, RT, AT, CT, and T* (open-bigram *T is activated when letter T is followed by a space), where * represents an edge or space. In contrast to other open-bigrams inside the string, an edge open-bigram cannot become partially activated (e.g., by the second or next-to-last letter).

At the word layer, the open-bigram units attach via weighted connections. The input to a word unit is represented by the dot-product of its respective number of open-bigram unit activations and the weighted connections to those open-bigrams units. Stated another way, it is the dot-product of the open-bigram unit's activation vector and the connection of the open-bigrams unit's weight vector. Commonly in neural networks models, the normalization of vector connection weights is assumed such that open-bigrams making up shorter words have higher connections weights than open-bigrams making up longer words. For example, the connection weights from CA, AN, and CN to the word-unit CAN are larger than the connections weights to the word-unit CANON. Hence, the stimulus can/would activate CAN more than CANON.

### Visual Perceptual Patterns

The SERIOL model assumes that the feature layer is comprised of features that are specific to alphanumeric-string serial processing. A stimulus would activate both alphanumeric-specific and general features. Alphanumeric-specific features would be subject to the locational gradient, while general features would reflect acuity. Alphanumeric-specific-features that activate alphanumeric representations would show the effects of string-specific serial processing. In particular, there will be an advantage if the letter or number character is the initial or last character of a string. However, if the symbol is not a letter or a number character, the alphanumeric-specific features will not activate an alphanumeric representation and there will be no alphanumeric-specific effects. Rather, the symbol will be recognized via the general visual features, where the effect of acuity predominates. An initial or last symbol in the string will be at a disadvantage because its acuity is lower than the acuity for the internal symbols in the string.

Two studies have examined visual perceptual patterns for letters versus non-alphanumeric characters in strings of centrally presented stimuli, using a between-subjects design for the different stimulus types (Hammond, E. J., & Green, D. W. (1982), Detecting targets in letter and non-letter arrays, Canadian Journal of Psychology, 36, 67-82). Both studies found an external-character advantage for letters. Specifically, the first and last letter characters were processed more efficiently than the internal letters characters. Mason also showed an external-character advantage for number strings (Mason, M. (1982), Recognition time for letters and non-letters: Effects of serial position, array size, and processing order, Journal of Experimental Psychology: Human Perception and Performance, 8, 724-738). However, both studies found that the advantage was absent for non-alphanumeric characters. The first and last symbol in a string were processed the least well in line with their lower acuity.

Using fixated strings containing both letters and non-alphanumeric characters, Tydgat and Grainger showed that an initial letter character in a string had a visual recognition advantage while an initial symbol (non-alphanumeric character) in the string did not. Thus, symbols that do not normally occur in strings show a different visual perceptual pattern than alphanumeric characters (Tydgat, I., and Grainger, J. (2009), Serial position effects in the identification of letters, digits, and symbols, J. Exp. Psychol. Hum. Percept. Perform. 35, 480-498). As described in more detail by Whitney & Cornelissen, the SERIOL model explains these visual perceptual patterns (Whitney, C., & Cornelissen, P. (2005), Letter-position encoding and dyslexia, Journal of Research in Reading, 28, 274-301; Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., & Cornelissen, P. (2005), Letter-position encoding and dyslexia, Journal of Research in Reading, 28, 274-301).

The external letter character advantage arises as follows. An advantage for the initial letter character in a string comes from the directional inhibition at the (retinotopic) feature level, because the initial letter character is the only letter character that does not receive lateral inhibition. An advantage for the final letter character arises at the (abstract) letter layer level, because the firing of the last letter character in a string is not terminated by a subsequent letter character. This serial positioning processing is specific to alphanumeric strings, thus explaining the lack of external character visual perceptual advantage for non-alphanumeric characters.

### Letter Position Parallel Encoding: The Grainger & Van Heuven Model

According to the Grainger and van Heuven model, parallel mapping of visual feature information at a specific location along the horizontal meridian with respect to eye fixation is mapped onto abstract letter representations that code for the presence of a given letter identity at that particular location (Grainger, J., & van Heuven, W. J. B. (2003), Modeling letter position coding in printed word perception, In P. Bonin (Ed.), Mental lexicon: “Some words to talk about words” (pp. 1-24). New York, N.Y.: Nova Science). In other words, this model proposes an “alphabetic array” retinotopic encoding consisting in a hypothesized bank of letter detectors that perform parallel, independent letter identification (any given letter has a separate representation for each retinal location). Grainger and van Heuven further proposed that these letters detectors are assumed to be invariant to the physical characteristics of letters and that these abstract letter representations are thought to be activated equally well by the same letter written in different case, in a different font, or a different size, but not invariant to position.

The next stage of processing, referred to as the “relative-position map”, is thought to code for the relative (within-stimulus) position of letters identities independently of their shape and their size, and independently of the location of the stimulus word (location invariance). This location-specific coding of letter identities is then transformed into a location invariant pre-lexical orthographic code (the relative-position map) before matching this information with whole-word orthographic representations in long-term memory. In essence, the relative-position map abstracts away from absolute letter position and focuses instead on relationships between letters. Therefore, in this model, the retinotopic alphabetic array is converted in parallel into an abstract open-bigram encoding that brings into play implicit relationships between letters. Specifically, this is achieved by open-bigram units that receive activation from the alphabetic array such that a given letter order D-E that is realized at any possible combinations of location in the retinotopic alphabetic array, activates the corresponding abstract open bigram for that sequence. Still, abstract open bigrams are activated by letter pairs that have up to two intervening letters. The abstract open-bigrams units then connect to word units. A key distinguishing virtue of this specific approach to letter position encoding rests on the assumption/claim that flexible orthographic coding is achieved by coding for ordered combinations of contiguous and non-contiguous letters pairs.

### Relationships Between Letters in a String—Coding Non-Contiguous Letter Combinations

Currently, there is a general consensus that the literate brain executes some form of word-centered, location-independent, orthographic coding such that letter identities are abstractly coded for their position in the word independent of their position on the retina (at least for words that require a single fixation for processing). This consensus also holds true for within-word position coding of letters identities to be flexible and approximate. In other words, letter identities are not rigidly allocated to a specific position. The corroboration for such flexibility and approximate orthographic encoding has been mainly classically obtained by utilizing the masked priming paradigm: for a given number of letters shared by the prime and target, priming effects are not affected by small changes of letter order (flexible and approximate letter position encoding)—transposed letter (TL) priming (Perea, M., and Lupker, S. J. (2004), Can CANISO activate CASINO? Transposed-letter similarity effects with nonadjacent letter positions, J. Mem. Lang. 51, 231-246; and Schoonbaert, S., and Grainger, J. (2004), Letter position coding in printed word perception: effects of repeated and transposed letters, Lang. Cogn. Process. 19, 333-367), and length-dependent letter position—relative-position priming (Peressotti, F., and Grainger, J. (1999), The role of letter identity and letter position in orthographic priming, Percept. Psychophys. 61, 691-706; and Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884).

Yet, the claim for a flexible and approximate orthographic encoding has extended to be also achieved by coding for letter combinations (Whitney, C., and Berndt, R. S. (1999), A new model of letter string encoding: simulating right neglect dyslexia, in Progress in Brain Research, eds J. A. Reggia, E. Ruppin, and D. Glanzman (Amsterdam: Elsevier), 143-163; Whitney, C. (2001), How the brain encodes the order of letters in a printed word: the SERIOL model and selective literature review, Psychon. Bull. Rev. 8, 221-243; Grainger, J., and van Heuven, W. J. B. (2003), Modeling letter position coding in printed word perception, in The Mental Lexicon, ed. P. Bonin (New York: Nova Science Publishers), 1-23; Dehaene, S., Cohen, L., Sigman, M., and Vinckier, F. (2005), The neural code for written words: a proposal, Trends Cogn. Sci. (Regul. Ed.) 9, 335-341). Letter combinations are classically and exclusively demonstrated by the use of contiguous letter combinations in n-gram coding and in particular by the use of non-contiguous letter combinations in n-gram coding. Dehaene has proposed that the coding of non-contiguous letter combinations arises as an artifact because of noisy erratic position retinotopic coding in location-specific letters detectors (Dehaene, S., Cohen, L., Sigman, M., and Vinckier, F. (2005), The neural code for written words: a proposal, Trends Cogn. Sci. (Regul. Ed.) 9, 335-341). In this scheme, the additional flexibility in orthographic encoding arises by accident, but the resulting flexibility is utilized to capture key data patterns.

In contrast, Dandurant has taken a different perspective, proposing that the coding of non-contiguous letter combinations is deliberate, and not the result of inaccurate location-specific letter coding (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In other words, non-contiguous letter combinations are coded because they are beneficial with respect to the overall goal of mapping letters onto meaning, not because the system is intrinsically noisy and therefore imprecise to determine the exact location of letters in a string. Dandurant et al., have examined two kinds of constrains that a reader should take into consideration when optimally processing orthographic information: 1) variations in letter visibility across the different letters of a word during a single fixation and 2) varying amount of information carried by the different letters in the word (e.g., consonants versus vowels letters). More specifically, they have hypothesized that this orthographic processing optimization would involve coding of non-contiguous letters combinations.

The reason for optimal processing of non-contiguous letter combinations can be explained on the following basis: 1) when selecting an ordered subset of letters which are critical to the identification of a word (e.g., the word “fatigue” can be uniquely identified by ordered letters substrings “ftge” and “atge” which result from dropping non-essential letters that bear little information), about half of the letters in the resulting subset are non-contiguous letters; and 2) the most informative pair of letters in a word is a non-contiguous pair of letters combination in 83% of 5-7 letter words (having no letter repetition) in English, and 78% in French and Spanish (the number of words included in the test set were 5838 in French, 8412 in English, and 4750 in Spanish) (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In summary, they concluded that an optimal and rational agent learning to read corpuses of real words should deliberately code for non-contiguous pair of letters (open-bigrams) based on informational content and given letters visibility constrains (e.g., initial, middle and last letters in an string of letters are more visually perceptually visible).

### Different Serial Position Effects in the Identification of Letters, Digits, and Symbols

In languages that use alphabetical orthographies, the very first stage of the reading process involves mapping visual features onto representations of the component letters of the currently fixated word (Grainger, J., Tydgat, I., and Isselé, J. (2010), Crowding affects letters and symbols differently, J. Exp. Psychol. Hum. Percept. Perform. 36, 673-688). Comparison of serial position functions using the target search task for letter stimuli versus symbol stimuli or simple shapes showed that search times for a target letter in a string of letters are represented by an approximate M-shape serial position function, where the shortest reaction times (RTs) were recorded for the first, third and fifth positions of a five-letter string (Estes, W. K., Allmeyer, D. H., & Reder, S. M. (1976), Serial position functions for letter identification at brief and extended exposure durations, Perception & Psychophysics, 19, 1-15). In contrast, a 5-symbol string (e.g., $, %, &) and shape stimuli shows a U-shape function with shortest RTs for targets at the central position on fixation that increase as a function of eccentricity (Hammond, E. J., & Green, D. W. (1982), Detecting targets in letter and non-letter arrays, Canadian Journal of Psychology, 36, 67-82).

A definitive interpretation of the different effect serial position has on letters and symbols is that it reflects the combination of two factors: 1) the drop of acuity from fixation to the periphery, and 2) less crowding on the first and last letter of the string because these letters are flanked by only one other letter (Bouma, H. (1973), Visual interference in the parafoveal recognition of initial and final letters of word, Vision Research, 13, 762-82). Specifically expanding on the second factor, Tydgat and Grainger proposed that crowding effects may be more limited in spatial extent for letter and number stimuli compared with symbol stimuli, such that a single flanking stimulus would suffice to generate almost maximum interference for symbols, but not for letters and numbers (Tydgat, I., and Grainger, J. (2009), Serial position effects in the identification of letters, digits, and symbols, J. Exp. Psychol. Hum. Percept. Perform. 35, 480-498). According to the Tydgat and Grainger interpretation of the different serial position functions for letters and symbols, one should be able to observe differential crowding effects for letters and symbols in terms of a superior performance at the first and last positions for letter stimuli but not for symbols or shapes stimuli. In a number of experiments they tested the hypothesis that a reduction in size of integration fields at the retinotopic layer, specific to stimuli that typically appear in strings (letters and digits), results in less crowding for such stimuli compared with other types of visual stimuli such as symbols and geometric shapes. In other words, the larger the integration field involved in identifying a given target at a given location, the greater the number of features from neighboring stimuli that can interfere in target identification. Stated another way, letter and digit stimuli benefit from a greater release from crowding effects (flanking letters or digits) at the outer positions than do symbol and geometric shape stimuli.

Still, critical spacing was found to be smaller for letters than for other symbols, with letter targets being identified more accurately than symbol targets at the lowest levels of inter-character spacing (manipulation of target-flankers spacing showed that symbols required a greater degree of separation [larger critical spacing] than letters in order to reach a criterion level of identification) (See experiment 5, Grainger, J., Tydgat, I., and Isselé, J. (2010), Crowding affects letters and symbols differently, J. Exp. Psychol. Hum. Percept. Perform. 36, 673-688). Most importantly, differential serial position crowding effects are of great importance given the fact that performance in the Two-Alternative Forced-Choice Procedure of isolated symbols and letters was very similar (Grainger, J., Tydgat, I., and Isselé, J. (2010), Crowding affects letters and symbols differently, J. Exp. Psychol. Hum. Percept. Perform. 36, 673-688).

Concerning the potential mechanism of crowding effects, Grainger et al. proposed bottom-up mechanisms whose operation can vary as a function of stimulus type via off-line as opposed to on-line influences. These off-line influences of stimulus type involved differences in perceptual learning driven by differential exposure to the different types of stimuli. Further, they proposed that when children learn to read, a specialized system develops in the visual cortex to optimize processing in the extremely crowded conditions that arise with printed words and numeric strings (e.g., in a two-stage retinotopic processing model: in the first-stage there is a detection of simple features in receptive fields of V1—0.1 ø and in a second-stage there is integration/interpretation in receptive fields of V4—0.5 ø [neurons in V4 are modulated by attention]) (See Levi, D. M., (2008), Crowding—An essential bottleneck for object recognition: A mini-review, Vision Research, 48, 635-654).

The central tenant here is that receptive field size of retinotopic letter and digit detectors has adapted to the need to optimize processing of strings of letters and digits and that the smaller the receptive field size of these detectors, the less interference there is from neighboring characters. One way to attain such processing optimization is being explained as a reduction in the size and shape of “integration fields.” The “integration field” is equivalent to a second-stage receptive field that combines the features by the earlier stage into an (object) alphanumeric character associated with location-specific letter detectors, “the alphabetic array”, that perform parallel letter identification compared with other visual objects that do not typically occur in such a cluttered environment (Dehaene, S., Cohen, L., Sigman, M., and Vinckier, F. (2005), The neural code for written words: a proposal, Trends Cogn. Sci. (Regul. Ed.) 9, 335-341; Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884; and Grainger, J., and van Heuven, W. J. B. (2003), Modeling letter position coding in printed word perception, in The Mental Lexicon, ed. P. Bonin (New York: Nova Science Publishers), 1-23).

Ktori, Grainger, Dufau provided further evidence on differential effects between letters and symbols stimuli (Maria Ktori, Jonathan Grainger & Stephan Dufau (2012), Letter string processing and visual short-term memory, The Quarterly Journal of Experimental Psychology, 65:3, 465-473). They study how expertise affects visual short-term memory (VSTM) item storage capacity and item encoding accuracy. VSTM is recognized as an important component of perceptual and cognitive processing in tasks that rest on visual input (Prime, D., & Jolicoeur, P. (2010), Mental rotation requires visual short-term memory: Evidence from human electric cortical activity, Journal of Cognitive Neuroscience, 22, 2437-2446). Specifically, Prime and Jolicoeur investigated whether the spatial layout of letters making up a string affects the accuracy with which a group of proficient adult readers performed a change-detection task (Luck, S. J. (2008), Visual short-term memory, In S. J. Luck & A. Hollingworth (Eds.), Visual memory (pp. 43-85). New York, N.Y.: Oxford University Press), item arrays that varied in terms of character type (letters or symbols), number of items (3, 5, and 7), and type of display (horizontal, vertical and circular) are used. Study results revealed an effect of stimulus familiarity significantly noticeable in more accurate change-detection responses for letters than for symbols. In line with the hypothesized experimental goals in the study, they found evidence that supports that highly familiar items, such as arrays of letters, are more accurately encoded in VSTM than unfamiliar items, such as arrays of symbols. More so, their study results provided additional evidence that expertise is a key factor influencing the accuracy with which representations are stored in VSTM. This was revealed by the selective advantage shown for letter over symbol stimuli when presented in horizontal compared to vertical or circular displays formats. The observed selective advantage of letters over symbols can be the result of years of reading that leads to expertise in processing horizontally aligned strings of letters so as to form word units in alphabetic languages such as English, French and Spanish.

In summary, the study findings support the argument that letter string processing is significantly influenced by the spatial layout of letters in strings in perfect agreement with other studies findings conducted by Grainger & van Heuven (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers and Tydgat, I., & Grainger, J. (2009), Serial position effects in the identification of letters, digits and symbols, Journal of Experimental Psychology: Human Perception and Performance, 35, 480-498).

Open Proto-Bigrams Embedded within Words (Subset Words) and as Standalone Connecting Word In-Between Words

A number of computational models have postulated open-bigrams as best means to substantiate a flexible orthographic encoding capable of explaining TL and RP priming effects. In the Grainger & van Heuven model the retinotopic alphabetic array is converted in parallel into an abstract open-bigram encoding that brings into play implicit relationships between letters (e.g., contiguous and non-contiguous) (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers). In the SERIOL model retinotopic visual stimuli presentation is mapped onto a temporal one where letter units recognize pairs of letter units (an open-bigram) that fire in a particular serial order; namely, space is mapped onto time to create an abstract invariant representation providing a location-invariant representation of letter order in a string (Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., and Cornelissen, P. (2005), Letter-position encoding and dyslexia, J. Res. Read. 28, 274-301). In these models, open-bigrams represent an abstract intermediary layer between letters and word units.

A key distinguishing virtue of this specific approach to letter position encoding rests on that flexible orthographic coding is achieved by coding for ordered combinations of contiguous and non-contiguous letters pairs, namely open-bigrams. For example, in the English language there are 676 pairs of letters combinations or open-bigrams (see Table 1 below). In addition to studies that have shown open-bigrams information processing differences between pair of letters entailing CC, VV, VC or CV, we introduce herein an additional open-bigrams novel property that should be interpreted as causing an automatic direct cascaded spread activation effect from orthography to semantics. Specifically, an open-bigram of the form VC or CV that is also a word carrying a semantic meaning such as for example: AM, AN, AS, AT, BE, BY, DO, GO, HE, IF, IN, IS, IT, ME, MY, NO, OF, ON, OR, SO, TO, UP, US, WE, is herein dubbed “open proto-bigram”. Still, these 24 open proto-bigrams that are also words represent 3.55% of all open-bigrams obtained from the English Language alphabet (see Table 1 below). Open proto-bigrams that are a subset word e.g., “BE” embedded in a word e.g., “BELOW” or are a subset word “HE” embedded in a superset word e.g., “SHE” or “THE” would not only indicate that the orthographic or phonological forms of the subset open proto-bigram word “HE” in the superset word “SHE” or “THE” or the subset open proto-bigram word “BE” in the word “BELOW” were activated in parallel, but also that these co-activated word forms triggered automatically and directly their corresponding semantic representations during the course of identifying the orthographic form of the word.

Based on the herein presented literature and novel teachings of the present subject matter, it is further assumed that this automatic bottom-up-top-down orthographic parallel-serial informational processing handshake, manifests in a direct cascade effect providing a number of advantages, thus facilitating the following perceptual-cognitive process: 1) fast lexical-sub-lexical recognition, 2) maximal chunking (data compression) of number of items in VSTM, 3) fast processing, 4) solid consolidation encoding in short-term memory (STM) and long-term memory (LTM), 5) fast semantic track for extraction/retrieval of word literal meaning, 6) less attentional cognitive taxing, 7) most effective activation of neighboring word forms, including multi-letter graphemes (e.g., th, ch) and morphemes (e.g., ing, er), 8) direct fast word recall that strongly inhibits competing or non-congruent distracting word forms; and 9) for a proficient reader, when open proto-bigrams are a standalone connecting a word unit in between words in a sentence, there is no need for (open proto-bigram) orthographic lexical pattern recognition and retrieval of their corresponding semantic literal information due to their super-efficient maximal chunking (data compression) and robust consolidation in STM-LTM. Namely, standalone open proto-bigrams connecting words in between words in sentences are automatically known implicitly. Thus, a proficient reader may also not consciously and explicitly pay attention to them and will therefore remain minimally aroused to their visual appearance.

TABLE 1
Open-Bigrams of the English Language

| | | | | | | | | | | | | | | | | | | | | | | | | | |
|---|---|---|---|---|---|---|---|---|---|---|---|---|---|---|---|---|---|---|---|---|---|---|---|---|---|
| aa | ab | ac | ad | ae | af | ag | ah | ai | aj | ak | al | am | an | ao | ap | aq | ar | as | at | au | av | aw | ax | ay | az |
| ba | bb | bc | bd | be | bf | bg | bh | bi | bj | bk | bl | bm | bn | bo | bp | bq | br | bs | bt | bu | by | bw | bx | by | bz |
| ca | cb | cc | cd | ce | cf | cg | ch | ci | cj | ck | cl | cm | cn | co | cp | cq | cr | cs | ct | cu | cv | cw | cx | cy | cz |
| da | db | dc | dd | de | df | dg | dh | di | d | dk | dl | dm | dn | do | dp | dq | dr | ds | dt | du | dv | dw | dx | dy | dz |
| ea | eb | ec | ed | ee | ef | eg | eh | ei | ej | ek | el | em | en | eo | ep | eq | er | es | et | eu | ev | ew | ex | ey | ez |
| fa | fb | fc | fd | fe | ff | fg | fh | fi | fj | fk | fi | fm | fn | fo | fp | fq | fr | fs | ft | fu | fv | fw | fx | fy | fz |
| ga | gb | gc | gd | ge | gf | gg | gh | gi | gj | gk | gl | gm | gn | go | gp | gq | gr | gs | gt | gu | gv | gw | gx | gy | gz |
| ha | hb | hc | hd | he | hf | hg | hh | hi | hj | hk | hl | hm | hn | ho | hp | hq | hr | hs | ht | hu | hv | hw | hx | hy | hz |
| ia | ib | ic | id | ie | if | ig | ih | ii | ij | ik | il | im | in | io | ip | iq | ir | is | it | iu | iv | iw | ix | iy | iz |
| ja | jb | jc | jd | je | jf | jg | jh | ji | jj | jk | jl | jm | jn | jo | jp | jq | jr | js | jt | ju | jv | jw | jx | jy | jz |
| ka | kb | kc | kd | ke | kf | kg | kh | ki | kj | kk | kl | km | kn | ko | kp | kq | kr | ks | kt | ku | kv | kw | kx | ky | kz |
| la | lb | lc | ld | le | lf | lg | lh | li | lj | lk | ll | lm | ln | lo | lp | lq | lr | ls | lt | lu | lv | lw | lx | ly | lz |
| ma | mb | mc | md | me | mf | mg | mh | mi | mj | mk | ml | mm | mn | mo | mp | mq | mr | ms | mt | mu | mv | mw | mx | my | mz |
| na | nb | nc | nd | ne | nf | ng | nh | ni | nj | nk | nl | nm | nn | no | np | nq | nr | ns | nt | nu | nv | nw | nx | ny | nz |
| oa | ob | oc | od | oe | of | og | oh | oi | oj | ok | ol | om | on | oo | op | oq | or | os | ot | ou | ov | ow | ox | oy | oz |
| pa | pb | pc | pd | pe | pf | pg | ph | pi | pj | pk | pl | pm | pn | po | pp | pq | pr | ps | pt | pu | pv | pw | px | py | pz |
| qa | qb | qc | qd | qe | qf | qg | qh | qi | qj | qk | ql | qm | qn | qo | qp | qq | qr | qs | qt | qu | qv | qw | qx | qy | qz |
| ra | rb | rc | rd | re | rf | rg | rh | ri | rj | rk | rl | rm | rn | ro | rp | rq | rr | rs | rt | ru | rv | rw | rx | ry | rz |
| sa | sb | sc | sd | se | sf | sg | sh | si | sj | sk | sl | sm | sn | so | sp | sq | sr | ss | st | su | sv | sw | sx | sy | sz |
| ta | tb | tc | td | te | tf | tg | th | ti | tj | tk | tl | tm | tn | to | tp | tq | tr | ts | tt | tu | tv | tw | tx | ty | tz |
| ua | ub | uc | ud | ue | uf | ug | uh | ui | uj | uk | ul | um | un | uo | up | uq | ur | us | ut | uu | uv | uw | ux | uy | uz |
| va | vb | vc | vd | ve | vf | vg | vh | vi | vj | vk | vl | vm | vn | vo | vp | vq | vr | vs | vt | vu | vv | vw | vx | vy | vz |
| wa | wb | wc | wd | we | wf | wg | wh | wi | wj | wk | wl | wm | wn | wo | wp | wq | wr | ws | wt | wu | wv | ww | wx | wy | wz |
| xa | xb | xc | xd | xe | xf | xg | xh | xi | xj | xk | xl | xm | xn | xo | xp | xq | xr | xs | xt | xu | xv | xw | xx | xy | xz |
| ya | yb | yc | yd | ye | yf | yg | yh | yi | yj | yk | yl | ym | yn | yo | yp | yq | yr | ys | yt | yu | yv | yw | yx | yy | yz |
| za | zb | zc | zd | ze | zf | zg | zh | zi | zj | zk | zl | zm | zn | zo | zp | zq | zr | zs | zt | zu | zv | zw | zx | zy | zz |

### Open Proto-Bigrams Words as Standalone Function Words in Between Words in Alphabetic Languages

Open-bigrams that are words (herein termed “open proto-bigrams), as for example: AM, AN, AS, AT, BE, BY, DO, GO, HE, IF, IN, IS, IT, ME, MY, NO, OF, ON, OR, SO, TO, UP, US, WE, belong to a linguistic class named ‘function words’. Function words either have reduced lexical or ambiguous meaning. They signal the structural grammatical relationship that words have to one another and are the glue that holds sentences together. Function words also specify the attitude or mood of the speaker. They are resistant to change and are always relatively few (in comparison to ‘content words’). Accordingly, open proto-bigrams (and other n-grams e.g. “THE”) words may belong to one or more of the following function words classes: articles, pronouns, adpositions, conjunctions, auxiliary verbs, interjections, particles, expletives and pro-sentences. Still, open proto-bigrams that are function words are traditionally categorized across alphabetic languages as belonging to a class named ‘common words’. In the English language, there are about 350 common words which stand for about 65-75% of the words used when speaking, reading and writing. These 350 common words satisfy the following criteria: 1) they are the most frequent/basic words of an alphabetic language; 2) they are the shortest words—up to 7 letters per word; and 3) they cannot be perceptually identified (access to their semantic meaning) by the way they sound; they must be recognized visually, and therefore are also named ‘sight words’.

Frequency Effects in Alphabetical Languages for: 1) Open Bigrams and 2) Open Proto-Bigrams Function Words as: a) Standalone Function Words in Between Words and b) as Subset Function Words Embedded within Words

Fifty to 75% of the words displayed on a page or articulated in a conversation are frequent repetitions of most common words. Just 100 different most common words in the English language (see Table 2 below) account for a remarkable 50% of any written text. Further, it is noteworthy that 22 of the above-mentioned open proto-bigrams function words are also most common words that appear within the 100 most common words, meaning that on average one in any two spoken or written words would be one of these 100 most common words. Similarly, the 350 most common words account for 65% to 75% of everything written or spoken, and 90% of any average written text or conversation will only need a vocabulary of common 7,000 words from the existing 1,000,000 words in the English language.

TABLE 2
Most Frequently Used Words Oxford Dictionary 11^{th} Edition

| | | | |
|---|---|---|---|
| 1 | the | 51 | when |
| 2 | be | 52 | make |
| 3 | to | 53 | can |
| 4 | of | 54 | like |
| 5 | and | 55 | time |
| 6 | a | 56 | no |
| 7 | in | 57 | just |
| 8 | that | 58 | him |
| 9 | have | 59 | know |
| 10 | I | 60 | take |
| 11 | it | 61 | person |
| 12 | for | 62 | into |
| 13 | not | 63 | year |
| 14 | on | 64 | your |
| 15 | with | 65 | good |
| 16 | he | 66 | some |
| 17 | as | 67 | could |
| 18 | you | 68 | them |
| 19 | do | 69 | see |
| 20 | at | 70 | other |
| 21 | this | 71 | than |
| 22 | but | 72 | then |
| 23 | his | 73 | now |
| 24 | by | 74 | look |
| 25 | from | 75 | only |
| 26 | they | 76 | come |
| 27 | we | 77 | its |
| 28 | say | 78 | over |
| 29 | her | 79 | think |
| 30 | she | 80 | also |
| 31 | or | 81 | back |
| 32 | an | 82 | after |
| 33 | will | 83 | use |
| 34 | my | 84 | two |
| 35 | one | 85 | how |
| 36 | all | 86 | our |
| 37 | would | 87 | work |
| 38 | there | 88 | first |
| 39 | their | 89 | well |
| 40 | what | 90 | way |
| 41 | so | 91 | even |
| 42 | up | 92 | new |
| 43 | out | 93 | want |
| 44 | if | 94 | because |
| 45 | about | 95 | any |
| 46 | who | 96 | these |
| 47 | get | 97 | give |
| 48 | which | 98 | day |
| 49 | go | 99 | most |
| 50 | me | 100 | us |

Most Frequently Used Words Oxford Dictionary 11^{th} Edition

Still, it is noteworthy that a large number of these 350 most common words entail 1 or 2 open pro-bigrams function words as embedded subset words within the most common word unit (see Table 3 below).

TABLE 3
Common Service and Nouns Words List
By: Edward William Dolch-Problems in Reading 1948
Dolch Word List Sorted Alphabetically by Grade with Nouns

| Pre-primer | Primer | First | Second | Third | Nouns | Nouns |
|---|---|---|---|---|---|---|
| a | all | after | always | about | apple | home |
| and | am | again | around | better | baby | horse |
| away | are | an | because | bring | back | house |
| big | at | any | been | carry | ball | kitty |
| blue | ate | as | before | clean | bear | leg |
| can | be | ask | best | cut | bed | letter |
| come | black | by | both | done | bell | man |
| down | brown | could | buy | draw | bird | men |
| find | but | every | call | drink | birthday | milk |
| for | came | fly | cold | eight | boat | money |
| funny | did | from | does | fall | box | morning |
| go | do | give | don't | far | boy | mother |
| help | eat | going | fast | full | bread | name |
| here | four | had | first | got | brother | nest |
| I | get | has | five | grow | cake | night |
| in | good | her | found | hold | car | paper |
| is | have | him | gave | hot | cat | party |
| it | he | his | goes | hurt | chair | picture |
| jump | into | how | green | if | chicken | pig |
| little | like | just | its | keep | children | rabbit |
| look | must | know | made | kind | Christmas | ran |

The teachings of the present subject matter are in perfect agreement with the fact that the brain's anatomical architecture constrains its perceptual-cognitive functional abilities and that some of these abilities become non-stable, decaying or atrophying with age. Indeed, slow processing speed, limited memory storage capacity, lack of sensory-motor inhibition and short attentional span and/or inattention, to mention a few, impose degrees of constrains upon the ability to visually, phonologically and sensory-motor implicitly pick-up, explicitly learn and execute the orthographic code. However, there are a number of mechanisms at play that develop in order to impose a number of constrains to compensate for limited motor-perceptual-cognitive resources. As previously mentioned, written words are visual objects before attaining the status of linguistic objects as has been proposed by McCandliss, Cohen, & Dehaene (McCandliss, B., Cohen, L., & Dehaene, S. (2003), The visual word form area: Expertise for reading in the fusiform gyrus, Trends in Cognitive Sciences, 13, 293-299) and there is pre-emption of visual object processing mechanisms during the process of learning to read (See also Dehaene et al., Local Combination Detector (LCD) model, Dehaene, S., Cohen, L., Sigman, M., and Vinckier, F. (2005), The neural code for written words: a proposal, Trends Cogn. Sci. (Regul. Ed.) 9, 335-341). In line with the latter, Grainger and van Heuven's alphabetic array is one such mechanism, described as a specialized system developed specifically for the processing of strings of alphanumeric stimuli (Grainger, J., & van Heuven, W. J. B. (2003), Modeling letter position coding in printed word perception, In P. Bonin (Ed.), Mental lexicon: “Some words to talk about words”. New York, N.Y.: Nova Science Publishers).

Another such mechanism at work is the high lexical-phonological information redundancies conveyed in speech and also found in the lexical components of an alphabetic language orthographic code. For example, relationships among letter combinations within a string and in between strings reflect strong letter combinations redundancies. Thus, the component units of the orthographic code implement frequent repetitions of some open bigrams in general and of all open proto-bigrams (that are words) in particular. In general, lexical and phonological redundancies in speech production and lexical redundancies in writing as reflected in frequent repetitions of some open bigrams and all open proto-bigrams within a string (a word) and among strings (words) in sentences reduces content errors in sender production of written-spoken messages making the spoken phonological-lexical message or orthographic code message resistant to noise or irrelevant contextual production substitutions, thereby increasing the interpretational semantic probability to comprehending the received message in its optimal context by the receiver.

Despite the above-mentioned brain anatomical constrains on function and related limited motor-perceptual-cognitive resources and how these constrains impact the handling of orthographic information, the co-occurrence of some open-bigrams and all open proto-bigrams in alphabetic languages renders alongside other developed compensatory specialized mechanisms at work (e.g. alphabetic array) an offset strategy that implements age-related, fast, coarse-lexical pattern recognition, maximal chunking (data compression) and optimal manipulation of alphanumeric-items in working memory-short-term memory (WM-STM), direct and fast access from lexical to semantics, robust semantic word encoding in STM-LTM and fast (non-aware) semantic word retrieval from LTM. On the other hand, the low co-occurrence of some open-bigrams in a word represent rare (low probability) letter combination events, and therefore are more informative concerning the specific word identity than frequent (predictable) occurring open-bigrams letter combination events in a word (Shannon, C. E. (1948), A mathematical theory of communication, Bell Syst. Tech. J. 27, 379-423). In brief, the low co-occurrence of some open-bigrams conveys most information that determines word identity (diagnostic feature).

Grainger and Ziegler explained that both types of constraints are driven by the frequency with which different combinations of letters occur in printed words. On one hand, frequency of occurrence determines the probability with which a given combination of letters belongs to the word being read. Letter combinations that are encountered less often in other words are more diagnostic (an informational feature that renders ‘word identity’) than the identity of the word being processed. In the extreme, a combination of letters that only occurs in a single word in the language, and is therefore a rarely occurring combination of letters event when considering the language as a whole, is highly informative with respect to word identity. On the other hand, the co-occurrence (high frequency of occurrence) enables the formation of higher-order representations (maximal chunking) in order to diminish the amount of information that is processed via data compression. Letter combinations (e.g., open-bigrams and trigrams) that often occur together can be usefully grouped to form higher-level orthographic representations such as multi-letter graphemes (th, ch) and morphemes (ing, er), thus providing a link with pre-existing phonological and morphological representations during reading acquisition (Grainger, J., & Ziegler, J. C. (2011), A dual-route approach to orthographic processing, Frontiers in Psychology, 2(54), 1-13).

The teachings of the present invention claim that open proto-bigram words are a special class/kind of coarse-grained orthographic code that computes (at the same time/in parallel) occurrences of contiguous and non-contiguous letters combinations (conditional probabilities of one or more subsets of open proto-bigram word(s)) within words and in between words (standalone open proto-bigram word) in order to rapidly hone in on a unique informational word identity alongside the corresponding semantic related representations, namely the fast lexical track to semantics (and correlated mental sensory-motor representation-simulation that grounds the specific semantic (word) meaning to the appropriate action).

### Aging and Language

Early research on cognitive aging has pointed out that language processing was spared in old age, in contradistinction to the decline in “fluid” (e.g. reasoning) intellectual abilities, such as remembering new information and in (sensory-motor) retrieving orthographic-phonologic knowledge (Botwinick, J. (1984), Aging and Behavior. New York: Springer). Still, research in this field strongly supports a general asymmetry in the effects of aging on language perception-comprehension versus production (input versus output processes). Older adults exhibit clear deficits in retrieval of phonological and lexical information from speech alongside retrieval of orthographic information from written language, with no corresponding deficits in language perception and comprehension, independent of sensory and new learning deficits. The input side of language includes visual perception of the letters and corresponding speech sounds that make up words and retrieval of semantic and syntactic information about words and sentences. These input-side language processes are commonly referred to as “language comprehension,” and they remain remarkably stable in old age, independent of age-linked declines in sensory abilities (Madden, D. J. (1988), Adult age differences in the effects of sentence context and stimulus degradation during visual word recognition, Psychology and Aging, 3, 167-172) and memory for new information (Light, L., & Burke, D. (1988), Patterns of language and memory in old age, In L. Light, & D. Burke, (Eds.), Language, memory and aging (pp. 244-271). New York: Cambridge University Press; Kemper, S. (1992b), Language and aging, In F. I. M. Craik & T. A. Salthouse (Eds.) The handbook of aging and cognition (pp. 213-270). Hillsdale, N.J.: Lawrence Erlbaum Associates; and Tun, P. A., & Wingfield, A. (1993), Is speech special? Perception and recall of spoken language in complex environments, In J. Cerella, W. Hoyer, J. Rybash, & M. L. Commons (Eds.) Adult information processing: Limits on loss (pp. 425-457) San Diego: Academic Press).

Tasks highlighting language comprehension processes, such as general knowledge and vocabulary scores in tests such as the Wechsler Adult Intelligence Scale, remain stable or improve with aging and provided much of the data for earlier conclusions about age constancy in language perception-comprehension processes. (Botwinick, J. (1984), Aging and Behavior, New York: Springer; Kramer, N. A., & Jarvik, L. F. (1979), Assessment of intellectual changes in the elderly, In A. Raskin & L. F. Jarvik (Eds.), Psychiatric symptoms and cognitive loss in the elderly (pp. 221-271). Washington, DC: Hemisphere Publishing; and Verhaeghen, P. (2003), Aging and vocabulary scores: A meta-analysis, Psychology and Aging, 18, 332-339). The output side of language involves retrieval of lexical and phonological information during everyday language production and retrieval of orthographic information such as unit components of words, during every day sensory-motor writing and typing activities. These output-side language processes, commonly termed “language production,” do exhibit age-related dramatic performance declines.

Aging has little effect on the representation of semantic knowledge as revealed, for example, by word associations (Burke, D., & Peters, L. (1986), Word associations in old age: Evidence for consistency in semantic encoding during adulthood, Psychology and Aging, 4, 283-292), script generation (Light, L. L., & Anderson, P. A. (1983), Memory for scripts in young and older adults, Memory and Cognition, 11, 435-444), and the structure of taxonomic categories (Howard, D. V. (1980), Category norms: A comparison of the Battig and Montague (1960) norms with the responses of adults between the ages of 20 and 80, Journal of Gerontology, 35, 225-231; and Mueller, J. H., Kausler, D. H., Faherty, A., & Oliveri, M. (1980), Reaction time as a function of age, anxiety, and typicality, Bulletin of the Psychonomic Society, 16, 473-476). Because comprehension involves mapping language onto existing knowledge structures, age constancy in the nature of these structures is important for maintaining language comprehension in old age. There is no age decrement in semantic processes in comprehension for both off-line and online measures of word comprehension in sentences (Speranza, F., Daneman, M., & Schneider, B. A. (2000) How aging affects reading of words in noisy backgrounds, Psychology and Aging, 15, 253-258). For example, the comprehension of isolated words in the semantic priming paradigm, particularly, the reduction in the time required to identify a target word (TEACHER) when it follows a semantically related word, (STUDENT) rather than a semantically unrelated word (GARDEN); here, perception of STUDENT primes semantically related information, automatically speeding recognition of TEACHER; and such semantic priming effects are at least as large in older adults as they are in young adults (Balota, D. A, Black, S., & Cheney, M. (1992), Automatic and attentional priming in young and older adults: Reevaluation of the two process model, Journal of Experimental Psychology: Human Perception and Performance, 18, 489-502; Burke, D., White, H., & Diaz, D. (1987), Semantic priming in young and older adults: Evidence for age-constancy in automatic and attentional processes, Journal of Experimental Psychology: Human Perception and Performance, 13, 79-88; Myerson, J. Ferraro, F. R., Hale, S., & Lima, S. D. (1992), General slowing in semantic priming and word recognition, Psychology and Aging, 7, 257-270; and Laver, G. D., & Burke, D. M. (1993), Why do semantic priming effects increase in old age? A meta-analysis, Psychology and Aging, 8, 34-43). Similarly, sentence context also primes comprehension of word meanings to an equivalent extent for young and older adults (Burke, D. M., & Yee, P. L. (1984), Semantic priming during sentence processing by young and older adults, Developmental Psychology, 20, 903-910; and Stine, E. A. L., & Wingfield, A. (1994), Older adults can inhibit high probability competitors in speech recognition, Aging and Cognition, 1, 152-157).

By contrast to the age constancy in comprehending semantic word meaning, extensive experimental research shows age-related declines in retrieving a name (less accurate and slower) corresponding to definitions, pictures or actions (Au, R., Joung, P., Nicholas, M., Obler, L. K., Kass, R. & Albert, M. L. (1995), Naming ability across the adult life span, Aging and Cognition, 2, 300-311; Bowles, N. L., & Poon, L. W. (1985), Aging and retrieval of words in semantic memory, Journal of Gerontology, 40, 71-77; Nicholas, M., Obler, L., Albert, M., & Goodglass, H. (1985), Lexical retrieval in healthy aging, Cortex, 21, 595-606; and Goulet, P., Ska, B., & Kahn, H. J. (1994), Is there a decline in picture naming with advancing age?, Journal of Speech and Hearing Research, 37, 629-644) and in the production of a target word given its definition and initial letter, or given its initial letter and general semantic category (McCrae, R. R., Arenberg, D., & Costa, P. T. (1987), Declines in divergent thinking with age: Cross-sectional, longitudinal, and cross-sequential analyses, Psychology and Aging, 2, 130-137).

Older adults rated word finding failures and tip of the tongue experiences (TOTs) as cognitive problems that are both most severe and most affected by aging (Rabbitt, P., Maylor, E., McInnes, L., Bent, N., & Moore, B. (1995), What goods can self-assessment questionnaires deliver for cognitive gerontology?, Applied Cognitive Psychology, 9, S127-S152; Ryan, E. B., See, S. K., Meneer, W. B., & Trovato, D. (1994), Age-based perceptions of conversational skills among younger and older adults, In M. L. Hummert, J. M. Wiemann, & J. N. Nussbaum (Eds.) Interpersonal communication in older adulthood (pp. 15-39). Thousand Oaks, Calif.: Sage Publications; and Sunderland, A., Watts, K., Baddeley, A. D., & Harris, J. E. (1986), Subjective memory assessment and test performance in the elderly, Journal of Gerontology, 41, 376-384). Older adults rated retrieval failures for proper names as especially common (Cohen, G., & Faulkner, D. (1984), Memory in old age: “good in parts” New Scientist, 11, 49-51; Martin, M. (1986); Ageing and patterns of change in everyday memory and cognition, Human Learning, 5, 63-74; and Ryan, E. B. (1992), Beliefs about memory changes across the adult life span, Journal of Gerontology: Psychological Sciences, 47, P41-P46) and the most annoying, embarrassing and irritating of their memory problems (Lovelace, E. A., & Twohig, P. T. (1990), Healthy older adults' perceptions of their memory functioning and use of mnemonics, Bulletin of the Psychonomic Society, 28, 115-118). They also produce more ambiguous references and pronouns in their speech, apparently because of an inability to retrieve the appropriate nouns (Cooper, P. V. (1990), Discourse production and normal aging: Performance on oral picture description tasks, Journal of Gerontology: Psychological Sciences, 45, P210-214; and Heller, R. B., & Dobbs, A. R. (1993), Age differences in word finding in discourse and nondiscourse situations, Psychology and Aging, 8, 443-450). Speech disfluencies, such as filled pauses and hesitations, increase with age and may likewise reflect word retrieval difficulties (Cooper, P. V. (1990), Discourse production and normal aging: Performance on oral picture description tasks, Journal of Gerontology: Psychological Sciences, 45, P210-214; and Kemper, S. (1992a), Adults' sentence fragments: Who, what, when, where, and why, Communication Research, 19, 444-458).

Further, TOT states increase with aging, accounting for one of the most dramatic instances of word finding difficulty in which a person is unable to produce a word although absolutely certain that they know it. Both naturally occurring TOTs (Burke, D. M., MacKay, D. G., Worthley, J. S., & Wade, E. (1991), On the tip of the tongue: What causes word finding failures in young and older adults, Journal of Memory and Language, 30, 542-579) and experimentally induced TOTs increase with aging (Burke, D. M., MacKay, D. G., Worthley, J. S., & Wade, E. (1991), On the tip of the tongue: What causes word finding failures in young and older adults, Journal of Memory and Language, 30, 542-579; Brown, A. S., & Nix, L. A. (1996), Age-related changes in the tip-of-the-tongue experience, American Journal of Psychology, 109, 79-91; James, L. E., & Burke, D. M. (2000), Phonological priming effects on word retrieval and tip-of-the-tongue experiences in young and older adults, Journal of Experimental Psychology: Learning. Memory, and Cognition, 26, 1378-1391; Maylor, E. A. (1990b), Recognizing and naming faces: Aging, memory retrieval and the tip of the tongue state, Journal of Gerontology: Psychological Sciences, 45, P215-P225; and Rastle, K. G., & Burke, D. M. (1996), Priming the tip of the tongue: Effects of prior processing on word retrieval in young and older adults, Journal of Memory and Language, 35, 586-605).

Still, word retrieval failures in young and especially older adults appear to reflect declines in access to phonological representations. Evidence for age-linked declines in language production has come almost exclusively from studies of word retrieval. MacKay and Abrams reported that older adults made certain types of spelling errors more frequently than young adults in written production, a sub-lexical retrieval deficit involving orthographic units (MacKay, D. G., Abrams, L., & Pedroza, M. J. (1999), Aging on the input versus output side: Theoretical implications of age-linked asymmetries between detecting versus retrieving orthographic information, Psychology and Aging, 14, 3-17). This decline occurred despite age equivalence in the ability to detect spelling errors and despite the higher vocabulary and education levels of older adults. The phonological/orthographic knowledge retrieval problem in old age is not due to deficits in formulating the idea to be expressed, but rather it appears to reflect an inability to map a well-defined idea or lexical concept onto its phonological and orthographic unit forms. Thus, unlike semantic comprehension of word meaning, which seems to be well-preserved in old age, sensory-motor retrieval of phonological and orthographic representations declines with aging.

### Language Production Deficits in Normal Aging and Open-Bigrams and Open Proto-Bigrams Priming

The teachings of the present invention are in agreement with some of the mechanisms and predictions of the transmission deficit hypothesis (TDH) computational model (Burke, D. M., Mackay, D. G., & James L. E. (2000), Theoretical approaches to language and aging, In T. J. Perfect & E. A. Maylor (Eds.), Models of cognitive aging (pp. 204-237). Oxford, England: Oxford University Press; and MacKay, D. G., & Burke, D. M. (1990), Cognition and aging: A theory of new learning and the use of old connections, In T. M. Hess (Ed.), Aging and cognition: Knowledge organization and utilization (pp. 213-263). Amsterdam: North Holland). Briefly, under the TDH, verbal information is represented in a network of interconnected units or nodes organized into a semantic system representing lexical and propositional meaning and a phonological system representing sounds. In addition to these nodes, there is a system of orthographic nodes with direct links to lexical nodes and also lateral links to corresponding phonological nodes (necessary for the production of novel words and pseudowords). In the TDH, language word comprehension (input) versus word production (output) differences arise from an asymmetrical structure of top-down versus bottom-up priming connections to the respective nodes.

In general, the present invention stipulates that normal aging weakens the priming effects of open-bigrams in words, particularly open proto-bigrams inside words and in between words in a sentence or fluent speech. This weakening priming effect of open proto-bigrams negatively impacts the direct lexical to semantics access route for automatically knowing the most common words in a language, and in particular, causes slow, non-accurate (spelling mistakes) recognition and retrieval of the orthographic code via writing and typing as well as slow, non-accurate (errors) or TOT of phonological and lexical information concerning particular types of naming word retrievals from speech. It is worth noticing that with aging, this priming weakening effect of open-bigrams and open proto-bigrams greatly diminishes the benefits of possessing a language with a high lexical-phonological information and lexical orthographic code representation redundancy. Therefore, it is to be expected that older individuals will increase content production errors in written-spoken messages, making phonological and lexical information via speech naming retrieval, and/or lexical orthographic production via writing, less resistant to noise. In other words, the early language advantage resting upon a flexible orthographic code and a flexible lexical-phonological informational encoding of speech becomes a disadvantage with aging since the orthographic or lexical-phonological code will become too flexible and prompt too many production errors.

The teachings of the present invention point out that language production deficits, particularly negatively affecting open-bigrams and open proto-bigrams when aging normally, promote an inefficient and noisy sensory-motor grounding of cognitive (top-down) fluent reasoning/intellectual abilities reflected in slow, non-accurate or wrong substitutions of ‘naming meaning’ in specific domains (e.g., names of people, places, dates, definitions, etc.) The teachings of the present invention further hypothesize that in a mild to severe progression Alzheimer's or dementia individual, language production deficits worsen and expand to also embrace wrong or non-sensory-motor grounding of cognitive (top-down) fluent reasoning/intellectual abilities thus causing a partial or complete informational disconnect/paralysis between object naming retrieval and the respective action-use domain of the retrieved object.

### A Novel Neuro-Performance Non-Pharmacological Alphabetic Language Based Technology

Without limiting the scope of the present invention, the teachings of the present invention disclose a non-pharmacological technology aiming to promote novel exercising of alphanumeric symbolic information. The present invention aims for a subject to problem solve and perform a broad spectrum of relationships among alphanumeric characters. For that purpose, direct and inverse alphabetical strings are herein presented comprising a constrained serial positioning order among the letter characters as well as randomized alphabetical strings comprising a non-constrained alphabetical serial positioning order among the letter characters. The herein presented novel exercises involve visual and/or auditory searching, identifying/recognizing, sensory-motor selecting and organizing of one or more open-bigrams and/or open proto-bigrams in order to promote fluid reasoning ability in a subject manifested in an effortless, fast and efficient problem solving of particular letter characters relationships in direct-inverse alphabetical and/or randomized alphabetical sequences. Still, the herein non-pharmacological technology, consist of novel exercising of open-bigrams and open proto-bigrams to promote: a) a strong grounding of lexical-phonological cognitive information in spoken language and of lexical orthographic unit components in writing language, b) a language neuro-prophylactic shielding against language production processing deficits in normal aging population, c) a language neuro-prophylactic shielding against language production processing deficits in MCI people, and d) a language neuro-prophylactic shielding against language production processing deficits capable of slowing down (or reversing) early mild neural degeneration cognitive adversities in Alzheimer's and dementia individuals.

Orthographic Sequential Encoded Regulated by Inputs to Oscillations within Letter Units (‘SERIOL’) Processing Model:

According to the SERIOL processing model, orthographic processing occurs at two levels-the neuronal level, and the abstract level. At the neuronal level, orthographic processing occurs progressively beginning from retinal coding (e.g., string position of letters within a string), followed by feature coding (e.g., lines, angles, curves), and finally letter coding (coding for letter nodes according to temporal neuronal firing.) At the abstract level, the coding hierarchy is (open) bigram coding (i.e., sequential ordered pairs of letters-correlated to neuronal firings according to letter nodes) followed by word coding (coding by: context units—words represented by visual factors—serial proximity of constituent letters). ((Whitney, C. (2001a), How the brain encodes the order of letters in a printed word: The SERIOL model and selective literature review, Psychonomic Bulletin and Review, 8, 221-243).

Some Statistical Aspects of Sequential Order of Letters and Letter Strings:

In the English language, in a college graduate vocabulary of about 20,000 letter strings (words), there are about only 50-60 words which obey a direct A-Z or indirect Z-A sequential incomplete alphabetical different letters serial order (e.g., direct A-Z “below” and inverse Z-A “the”). More so, about 40% of everything said, read or written in the English language consists of frequent repetitions of open proto-bigrams (e.g., is, no, if, or etc.) words in between words in written sentences or uttered words in between uttered words in a conversation. In the English language, letter trigrams frequent repetitions (e.g. “the”, ‘can’, ‘his’, ‘her’, ‘its’, etc.) constitute more than 10% of everything said, read or written.

### Methods

The definition given to the terms below is in the context of their meaning when used in the body of this application and in its claims.

The below definitions, even if explicitly referring to letters sequences, should be considered to extend into a more general form of these definitions to include numerical and alphanumerical sequences, based on predefined complete numerical and alphanumerical set arrays and a formulated meaning for pairs of non-equal and non-consecutive numbers in the predefined set array, as well as for pairs of alphanumeric characters of the predefined set array.

A “series” is defined as an orderly sequence of terms

“Serial terms” are defined as the individual components of a series.

A “serial order” is defined as a sequence of terms characterized by: (a) the relative ordinal spatial position of each term and the relative ordinal spatial positions of those terms following and/or preceding it; (b) its sequential structure: an “indefinite serial order,” is defined as a serial order where no first neither last term are predefined; an “open serial order.” is defined as a serial order where only the first term is predefined; a “closed serial order,” is defined as a serial order where only the first and last terms are predefined; and (c) its number of terms, as only predefined in ‘a closed serial order’.

“Terms” are represented by one or more symbols or letters, or numbers or alphanumeric symbols.

“Arrays” are defined as the indefinite serial order of terms. By default, the total number and kind of terms are undefined.

“Terms arrays” are defined as open serial orders of terms. By default, the total number and kind of terms are undefined.

“Set arrays” are defined as closed serial orders of terms, wherein each term is intrinsically a different member of the set and where the kinds of terms, if not specified in advance, are undefined. If, by default, the total number of terms is not predefined by the method(s) herein, the total number of terms is undefined.

“Letter set arrays” are defined as closed serial orders of letters, wherein same letters may be repeated.

An “alphabetic set array” is a closed serial order of letters, wherein all the letters are predefined to be different (not repeated). Still, each letter member of an alphabetic set array has a predefined different ordinal position in the alphabetic set array. An alphabetic set array is herein considered to be a Complete Non-Randomized alphabetical letters sequence. Letter symbol members are herein only graphically represented with capital letters. For single letter symbol members, the following complete 3 direct and 3 inverse alphabetic set arrays are herein defined:

Direct alphabetic set array: A, B, C, D, E, F, G, H, I, J, K, L, M, N, O, P, Q, R, S, T, U, V, W, X, Y, Z.

Inverse alphabetic set array: Z, Y, X, W, V, U, T, S, R, Q, P, O, N, M, L, K, J, I, H, G, F, E, D, C, B, A.

Direct type alphabetic set array: A, Z, B, Y, C, X, D, W, E, V, F, U, G, T, H, S, I, R, J, Q, K, P, L, O, M, N.

Inverse type alphabetic set array: Z, A, Y, B, X, C, W, D, V, E, U, F, T, G, S, H, R, I, Q, J, P, K, O, L, N, M.

Central type alphabetic set array: A, N, B, O, C, P, D, Q, E, R, F, S, G, T, H, U, I, V, J, W, K, X, L, Y, M, Z.

Inverse central type alphabetic set array: N, A, O, B, P, C, Q, D, R, E, S, F, T, G, U, H, V, I, W, J, X, K, Y, L, Z, M.

An “open bigram,” if not specified otherwise, is herein defined as a closed serial order formed by any two contiguous or non-contiguous letters of the above alphabetic set arrays. Under the provisions set forth above, an “open bigram” may also refer to pairs of numerical or alpha-numerical symbols.

For Alphabetic Set Arrays where the Members are Defined as Open Bigrams, the Following 3 Direct and 3 Inverse Alphabetic Open Bigrams Set Arrays are Herein Defined

Direct alphabetic open bigram set array: AB, CD, EF, GH, IJ, KL, MN, OP, QR, ST, UV, WX, YZ.

Inverse alphabetic open bigram set array: ZY, XW, VU, TS, RQ, PO, NM, LK, JI, HG, FE, DC, BA.

Direct alphabetic type open bigram set array: AZ, BY, CX, DW, EV, FU, GT, HS, IR, JQ, KP, LO, MN.

Inverse alphabetic type open bigram set array: ZA, YB, XC, WD, VE, UF, TG, SH, RI, QJ, PK, OL, NM.

Central alphabetic type open bigram set array: AN, BO, CP, DQ, ER, FS, GT, HU, IV, JW, KX, LY, MZ.

Inverse alphabetic central type open bigram set array: NA, OB, PC, QD, RE, SF, TG, UH, VI, WJ, XK, YL, ZM.

An “open bigram term” is a lexical orthographic unit characterized by a pair of letters (n-gram) depicting a minimal sequential order consisting of two letters. The open bigram class to which an open bigram term belongs may or may not convey an automatic direct access to semantic meaning in an alphabetic language to a reader.

An “open bigram term sequence” is a letters symbol sequence, where two letter symbols are presented as letter pairs representing a term in the sequence, instead of an individual letter symbol representing a term in the sequence.

There are 4 classes of Open Bigram terms, there being a total of 676 different open bigram terms in the English alphabetical language

Class I—Within the context of the present subject matter, Class I always refers to “open proto-bigram terms”. Specifically, there are 24 open proto-bigram terms in the English alphabetical language.

Class II—Within the context of the present subject matter, Class II consists of open bigram terms entailed in alphabetic open bigram set arrays (6 of these alphabetic open bigram set arrays are herein defined for the English alphabetical language). Specifically, Class II comprises a total of 78 different open bigram terms wherein 2 open bigram terms are also open bigram terms members of Class I.

Class III—Within the context of the present subject matter, Class III entails the vast majority of open bigram terms in the English alphabetical language except for all open bigram terms members of Classes I, II, and IV. Specifically, Class III comprises a total of 550 open bigram terms.

Class IV— Within the context of the present subject matter, Class IV consists of open bigram terms entailing repeated single letters symbols. For the English alphabetical language, Class IV comprises a total of 26 open bigram terms.

An alphabetic “open proto-bigram term” (see Class I above) is defined as a lexical orthographic unit characterized by a pair of letters (n-gram) depicting the smallest sequential order of contiguous and non-contiguous different letters that convey an automatic direct access to semantic meaning in an alphabetical language (e.g., English alphabetical language: an, to, so etc.).

An “open proto-bigram sequence type” is herein defined as a complete alphabetic open proto-bigram sequence characterized by the pairs of letters comprising each open proto-bigram term in a way that the serial distribution of such open proto-bigram terms establishes a sequence of open proto-bigram terms type that follows a direct or an inverse alphabetic set array order. In summary, there are two complete alphabetic open proto-bigram sequence types.

Types of Open Proto-Bigram Sequences:

Direct type open proto-bigram sequence: AM, AN, AS, AT, BE, BY, DO, GO, IN, IS, IT, MY, NO, OR

Inverse type open proto-bigram sequence: WE, US, UP, TO, SO, ON, OF, ME, IF, HE.

“Complete alphabetic open proto-bigram sequence groups” within the context of the present subject matter, Class I open-proto bigram terms, are further grouped in three sequence groups:

Open Proto-Bigram Sequence Groups:

Left Group: AM, BE, HE, IF, ME

Central Group: AN, AS, AT, BY, DO, GO, IN, IS, IT, MY, OF, WE

Right Group: NO, ON, OR, SO, TO, UP, US

The term “collective critical space” is defined as the alphabetic space in between two non-contiguous ordinal positions of a direct or inverse alphabetic set array. A “collective critical space” further corresponds to any two non-contiguous letters which form an open proto-bigram term. The postulation of a “collective critical space” is herein contingent to any pair of non-contiguous letter symbols in a direct or inverse alphabetic set array, where their orthographic form directly and automatically conveys a semantic meaning to the subject.

The term “virtual sequential state” is herein defined as an implicit incomplete alphabetic sequence made-up of the letters corresponding to the ordinal positions entailed in a “collective critical space”. There is at least one implicit incomplete alphabetic sequence entailed per each open proto-bigram term. These implicit incomplete alphabetic sequences are herein conceptualized to exist in a virtual perceptual-cognitive mental state of the subject. Every time that this virtual perceptual-cognitive mental state is grounded by means of a programmed goal oriented sensory-motor activity in the subject, his/her reasoning and mental cognitive ability is enhanced.

From the above definitions, it follows that a letters sequence, which at least entails two non-contiguous letters forming an open proto-bigram term, will possess a “collective critical spatial perceptual related attribute” as a direct consequence of the implicit perceptual condition of the at least one incomplete alphabetic sequence arising from the “virtual sequential state” in correspondence with the open proto-bigram term. This virtual/abstract serial state becomes concrete every time a subject is required to reason and perform goal oriented sensory motor action to problem solve a particular kind of serial order involving relationships among alphabetic symbols in a sequence of symbols. One way of promoting this novel reasoning ability is achieved through a predefined goal oriented sensory motor activity of the subject by performing a data “compression” of a selected letters sequence or by performing a data “expansion” of a selected letters sequence in accordance with the definitions of the terms given below.

Moreover, as already indicated above for a general form of these definitions, for a predefined Complete Numerical Set Array and a predefined Complete Alphanumeric Set Array, the “collective critical space”, “virtual sequential state” and “collective critical spatial perceptual related attribute” for alphabetic series can also be extended to include numerical and alphanumerical series.

An “ordinal position” is defined as the relative position of a term in a series, in relation to the first term of this series, which will have an ordinal position defined by the first integer number (#1), and each of the following terms in the sequence with the following integer numbers (#2, #3, #4, . . . ). Therefore, the 26 different letter terms of the English alphabet will have 26 different ordinal positions which, in the case of the direct alphabetic set array (see above), ordinal position #1 will correspond to the letter “A”, and ordinal position #26 will correspond to the letter “Z”.

An “alphabetic letter sequence,” unless otherwise specified, is herein one or more complete alphabetic letter sequences from the group comprising: Direct alphabetic set array, Inverse alphabetic set array, Direct open bigram set array, Inverse open bigram set array, Direct open proto-bigram sequence, and Inverse open proto-bigram sequence.

The term “incomplete” serial order refers herein only in relation to a serial order which has been previously defined as “complete.”

As used herein, the term “relative incompleteness” is used in relation to any previously selected serial order which, for the sake of the intended task herein required performing by a subject, the said selected serial order could be considered to be complete.

As used herein, the term “absolute incompleteness” is used only in relation to alphabetic set arrays, because they are defined as complete closed serial orders of terms (see above). For example, in relation to an alphabetic set array, incompleteness is absolute, involving at the same time: number of missing letters, type of missing letters and ordinal positions of missing letters.

A “non-alphabetic letter sequence” is defined as any letter series that does not follow the sequence and/or ordinal positions of letters in any of the alphabetic set arrays.

A “symbol” is defined as a mental abstract graphical sign/representation, which includes letters and numbers.

A “letter term” is defined as a mental abstract graphical sign/representation, which is generally, characterized by not representing a concrete: thing/item/form/shape in the physical world. Different languages may use the same graphical sign/representation depicting a particular letter term, which it is also phonologically uttered with the same sound (like “s”).

A “letter symbol” is defined as a graphical sign/representation depicting in a language a letter term with a specific phonological uttered sound. In the same language, different graphical sign/representation depicting a particular letter term, are phonologically uttered with the same sound(s) (like “a” and “A”).

An “attribute” of a term (alphanumeric symbol, letter, or number) is defined as a spatial distinctive related perceptual feature and/or time distinctive related perceptual feature. An attribute of a term can also be understood as a related on-line perceptual representation carried through a mental simulation that effects the off-line conception of what it's been perceived. (Louise Connell, Dermot Lynott. Principles of Representation: Why You Can't Represent the Same Concept Twice. Topics in Cognitive Science (2014) 1-17)

A “spatial related perceptual attribute” is defined as a characteristically spatial related perceptual feature of a term, which can be discriminated by sensorial perception. There are two kinds of spatial related perceptual attributes.

An “individual spatial related attribute” is defined as a spatial related perceptual attribute that pertains to a particular term. Individual spatial related perceptual attributes include, e.g., symbol case; symbol size; symbol font; symbol boldness; symbol tilted angle in relation to a horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

A “collective spatial related attribute” is defined as a spatial related perceptual attribute that pertains to the relative location of a particular term in relation to the other terms in a letter set array, an alphabetic set array, or an alphabetic letter symbol sequence. Collective spatial related attributes (e.g. in a set array) include a symbol ordinal position, the physical space occupied by a symbol font, the distance between the physical spaces occupied by the fonts of two consecutive symbols/terms when represented in orthographical form, and left or right relative edge position of a term/symbol font in a set array. Even if triggering a sensorial perceptual relation with the reasoning subject, a “collective spatial related perceptual attribute” is not related to the semantic meaning of the one or more letter symbols possessing this spatial perceptual related attribute. In contrast, the “collective critical space” is contingent on the generation of a semantic meaning in a subject by the pair of non-contiguous letter symbols implicitly entailing this collective critical space.

A “time related perceptual attribute” is defined as a characteristically temporal related perceptual feature of a term (symbol, letter or number), which can be discriminated by sensorial perception such as: a) any color of the RGB full color range of the symbols term; b) frequency range for the intermittent display of a symbol, of a letter or of a number, from a very low frequency rate, up till a high frequency (flickering) rate. Frequency is quantified as: 1/t, where t is in the order of seconds of time; c) particular sound frequencies by which a letter or a number is recognized by the auditory perception of a subject; and d) any herein particular constant motion represented by a constant velocity/constant speed (V) at which symbols, letters, and/or numbers move across the visual or auditory field of a subject. In the case of Doppler auditory field effect, where sounds representing the names of alphanumeric symbols, letters, and/or numbers are approximating or moving away in relation to a predefined point in the perceptual space of a subject, constant motion is herein represented by the speed of sound. By default, this constant motion of symbols, letters, and/or numbers is herein considered to take place along a horizontal axis, in a spatial direction to be predefined. If the visual perception of constant motion is implemented on a computer screen, the value of V to be assigned is given in pixels per second at a predefined screen resolution.

It has been empirically observed that when the first and last letter symbols of a word are maintained, the reader's semantic meaning of the word may not be altered or lost by removing one or more letters in between them. This orthographic transformation is named data “compression”. Consistent with this empirical observation, the notion of data “compression” is herein extended into the following definitions:

If a “symbols sequence is subject to compression” which is characterized by the removal of one or more contiguous symbols located in between two predefined symbols in the sequence of symbols, the two predefined symbols may, at the end of the compression process, become contiguous symbols in the symbols sequence, or remain non-contiguous if the omission or removal of symbols is done on non-contiguous symbols located between the two predefined symbols in the sequence.

Due to the intrinsic semantic meaning carried by an open proto-bigram term, when the two predefined symbols in a sequence of symbols are the two letters symbols forming an open proto-bigram term, the compression of a letter sequence is considered to take place at two sequential levels, “local” and “non-local”, and the non-local sequential level comprises an “extraordinary sequential compression case.”

A “local open proto-bigram term compression” is characterized by the omission or removal of one or two contiguous letters in a sequence of letters lying in between the two letters that form/assemble an open proto-bigram term, by which the two letters of the open proto-bigram term become contiguous letters in the letters sequence.

A “non-local open proto-bigram compression” is characterized by the omission or removal of more than two contiguous letters in a sequence of letters, lying in between two letters at any ordinal serial position in the sequence that form an open proto-bigram term, by which the two letters of the open proto-bigram term become contiguous letters in the letters sequence.

An “extraordinary non-local open proto-bigram compression” is a particular case of a non-local open proto-bigram term compression, which occurs in a letters sequence comprising N letters when the first and last letters in the letters sequence are the two selected letters forming/assembling an open proto-bigram term, and the N-2 letters lying in between are omitted or removed, by which the remaining two letters forming/assembling the open proto-bigram term become contiguous letters.

An “alphabetic expansion” of an open proto-bigram term is defined as the orthographic separation of its two (alphabetical non-contiguous letters) letters by the serial sensory motor insertion of the corresponding incomplete alphabetic sequence directly related to its collective critical space according to predefined timings. This sensory motor ‘alphabetic expansion’ will explicitly make the particular related virtual sequential state entailed in the collective critical space of this open proto-bigram term concrete.

“Orthographic letters contiguity” is defined as the contiguity of letters symbols in a written form by which words are represented in most written alphabetical languages.

For “alphabetic contiguity,” a visual recognition facilitation effect occurs for a pair of letters forming any open bigram term, even when 1 or 2 letters in orthographic contiguity lying in between these two (now) edge letters form the open bigram term. It has been empirically confirmed that up to 2 letters located contiguously in between the open bigram term do not interfere with the visual identity and resulting perceptual recognition process of the pair of letters making-up the open bigram term. In other words, the visual perceptual identity of an open bigram term (letter pair) remains intact even in the case of up two letters held in between these two edge letters forming the open bigram term.

However, in the particular case where open bigram terms orthographically directly convey/communicate a semantic meaning in a language (e.g., open proto-bigrams), it is herein considered that the visual perceptual identity of open proto-bigram terms remains intact even when more than 2 letters are held in between the now edge letters forming the open proto-bigram term. This particular visual perceptual recognition effect is considered as an expression of: 1) a Local Alphabetic Contiguity effect—empirically manifested when up to two letters are held in between (LAC) for open bigrams and open proto-bigrams terms and 2) a Non-Local Alphabetic Contiguity (NLAC) effect—empirically manifested when more than two letters are held in between, an effect which only take place in open proto-bigrams terms.

Both LAC and NLAC are part of a herein novel methodology aiming to advance a flexible orthographic decoding and processing view concerning sensory motor grounding of perceptual-cognitive alphabetical, numerical, and alphanumeric information/knowledge. LAC correlates to the already known priming transposition of letters phenomena, and NLAC is a new proposition concerning the visual perceptual recognition property particularly possessed only by open proto-bigrams terms which is enhanced by the performance of the herein proposed methods. For the 24 open proto-bigram terms found in the English language alphabet, 7 open proto-bigram terms are of a default LAC consisting of 0 to 2 in between ordinal positions of letters in the alphabetic direct-inverse set array because of their unique respective intrinsic serial order position in the alphabet. The remaining 17 open proto-bigrams terms are of a default NLAC consisting of an average of more than 10 letters held in between ordinal positions in the alphabetic direct-inverse set array.

The present subject matter considers the phenomena of ‘alphabetic contiguity’ being a particular top-down cognitive-perceptual mechanism that effortlessly and autonomously causes arousal inhibition in the visual perception process for detecting, processing, and encoding the N letters held in between the 2 edge letters forming an open proto-bigram term, thus resulting in maximal data compression of the letters sequence. As a consequence of the alphabetic contiguity orthographic phenomena, the space held in between any 2 non-contiguous letters forming an open proto-bigram term in the alphabet is of a critical perceptual related nature, herein designated as a ‘Collective Critical Space Perceptual Related Attribute’ (CCSPRA) of the open proto-bigram term, wherein the letters sequence which is attentionally ignored-inhibited, should be conceptualized as if existing in a virtual mental kind of state. This virtual mental kind of state will remain effective even if the 2 letters making-up the open proto-bigram term will be in orthographic contiguity (maximal serial data compression).

When the 2 letters forming an open proto-bigram term hold in between a number of N letters and when the serial ordinal position of these two letters are the serial position of the edge letters of a letters sequence (meaning that there are no additional letters on either side of these two edge letters), the alphabetic contiguity property will only pertain to these 2 edge letters forming the open proto-bigram term. In brief, this particular case discloses the strongest manifestation of the alphabetic contiguity property, where one of the letters making up an open proto-bigram term is the head and the other letter is the tail of a letters sequence. This particular case is herein designated as Extraordinary NLAC.

An “arrangement of terms” (symbols, letters and/or numbers) is defined as one of two classes of term arrangements, i.e., an arrangement of terms along a line, or an arrangement of terms in a matrix form. In an “arrangement along a line,” terms will be arranged along a horizontal line by default. If for example, the arrangement of terms is meant to be along a vertical or diagonal or curvilinear line, it will be indicated. In an “arrangement in a matrix form,” terms are arranged along a number of parallel horizontal lines (like letters arrangement in a text book format), displayed in a two dimensional format.

The terms “generation of terms,” “number of terms generated” (symbols, letters and/or numbers) is defined as terms generally generated by two kinds of term generation methods—one method wherein the number of terms is generated in a predefined quantity; and another method wherein the number of terms is generated by a quasi-random method.

It is important to point out/consider that, in the above method of promoting reasoning abilities and in the following exercises and examples implementing the method, the subject is performing the discrimination of open bigrams or open proto-bigram terms in an array/series of open bigrams and/or open proto-bigram sequences without invoking explicit conscious awareness concerning underlying implicit governing rules or abstract concepts/interrelationships, characterized by relations or correlations or cross-correlations among the searched, discriminated and sensory motor manipulated open bigrams and open proto-bigrams terms by the subject. In other words, the subject is performing the search and discrimination without overtly thinking or strategizing about the necessary actions to effectively accomplish the sensory motor manipulation of the open bigrams and open proto-bigram terms.

As mentioned in connection with the general form of the above definitions, the herein presented suite of exercises can make use of not only letters but also numbers and alphanumeric symbols relationships. These relationships include correlations and cross-correlations among open bigrams and/or open proto-bigram terms such that the mental ability of the exercising subject is able to promote novel reasoning strategies that improve fluid intelligence abilities. The improved fluid intelligence abilities will be manifested in at least effective and rapid mental simulation, novel problem solving, drawing inductive-deductive inferences, pattern and irregularities recognition, identifying relations, correlations and cross-correlations among sequential orders of symbols comprehending implications, extrapolating, transforming information and abstract concept thinking.

As mentioned earlier, it is also important to consider that the methods described herein are not limited to only alphabetic symbols. It is also contemplated that the methods of the present subject can involve numeric serial orders and/or alpha-numeric serial orders to be used within the exercises. In other words, while the specific examples set forth employ serial orders of letter symbols, alphabetic open bigram terms and alphabetic open proto-bigram terms, it is contemplated that serial orders comprising numbers and/or alpha-numeric symbols can be used.

A library of open-bigram sequences comprises those obtained with letter symbols from alphabetic set arrays, which may include open-bigram sequences derived from other set arrays (of numerical or alphanumerical symbols). Alphabetic set arrays are characterized by comprising a predefined number of different letter terms, each letter term having a predefined unique ordinal position in the closed set array, and none of said different letter terms are repeated within this predefined unique serial order of letter terms. A non-limiting example of a unique letter set array is the English alphabet, in which there are 13 predefined different open-bigram terms where each open-bigram term has a predefined consecutive ordinal position of a unique closed serial order among 13 different members of an open-bigram set array only comprising 13 members.

In one aspect of the present subject matter, a predefined library of complete alphabetic open-bigrams sequences is herein considered. The English alphabet is herein considered as a direct alphabetic set array, from which only one unique serial order of open-bigram terms is obtained. There are at least five other different unique alphabetic set arrays herein considered. As mentioned above, the English alphabet is a particular alphabetic set array herein denominated as a direct alphabetic set array. There are other five different alphabetic set arrays contemplated from which another five unique alphabetic open-bigram set arrays are obtained, denominated herein as: inverse alphabetic open-bigram set array, direct type of alphabetic open-bigram set array, inverse type of alphabetic open-bigram set array, central type of alphabetic open-bigram set array, and inverse central type alphabetic open-bigram set array. It is understood that the above predefined library of open-bigram terms sequences may contain fewer open-bigram terms sequences than those listed above or that it may comprise more different open-bigram sequences.

In an aspect of the present methods, the at least one unique serial order comprises a sequence of open-bigram terms. In this aspect of the present subject matter, the predefined library of open-bigram sequences may comprise the following sequential orders of open-bigrams terms, where each open-bigram term is a different member of a set array having a predefined unique ordinal position within the set: direct open-bigram set array, inverse open-bigram set array, direct type open-bigram set array, inverse type open-bigram set array, central type open-bigram set array, and inverse central type open-bigram set array. It is understood that the above predefined library of open-bigram sequences may contain additional or fewer open-bigram sequences than those listed above.

In each of the non-limiting Examples below, the subject is presented with various exercises and prompted to make selections based upon the particular features of the exercises. It is contemplated that, within the non-limiting Examples, the choice method presented to the subject could be any one of three particular non-limiting choice methods: multiple choice, force choice, and/or go-no-go choice.

When the subject is provided with multiple choices when performing the exercise, the subject is presented multiple choices as to what the possible answer is. The subject must discern the correct answer/selection and select the correct answer from the given multiple choices.

When the force choice method is employed within the exercises, the subject is presented with two alternatives for the correct answer and, as is implicit in the name, the subject is forced to make that choice. In other words, the subject is forced to select the correct answer from the two possible answers presented to the subject.

Likewise, a choice method presented to the subject is a go-no-go choice method. In this method, the subject is prompted to answer every time the subject is exposed to the possible correct answer. In a non-limiting example, the subject may be requested to click or not on a particular button each time a certain open-bigram term is shown to the subject. Alternatively, the subject may be requested to click on one of two different buttons each time another certain open-bigram term is displayed. Thus, the subject clicks on one of the two buttons when his/her reasoning indicates that the correct open-bigram term appears and does not click on the other button if his/her reasoning indicates that the correct open-bigram term is not there.

In another aspect of the each of the non-limiting examples described herein, the change in attributes is done according to predefined correlations between spatial and time perceptual related attributes and the ordinal position of the open-bigram terms. As a non-limiting example, for the particular case of a complete direct alphabetic set array of the English language falling inside the perceptual visual field of the subject, the first ordinal position (occupied by the letter “A”), will generally appear towards the left side of his/her fields of vision, whereas the last ordinal position (occupied by the letter “Z”) will appear towards his/her right visual field of vision. Further, if the ordinal position of the open-bigram term for which an attribute will be changed falls in the left field of vision, the change in attribute may be different than if the ordinal position of the open-bigram term for which the attribute will be changed falls in the right field of vision.

In this non-limiting example, if the attribute to be changed is the color of the open-bigram term, and if the ordinal position of the open-bigram term for which the attribute will be changed falls in the left field of vision, then the color will be changed to a first different color, while if the ordinal position of the open-bigram term falls in the right field of vision, then the color will be changed to a second color different from the first color. Likewise, if the attribute to be changed is the size of the open-bigram term being displayed, then those open-bigram terms with an ordinal position falling in the left field of vision will be changed to a first different size, while the open-bigram terms with an ordinal position falling in the right field of vision will be changed to a second different size that is also different than the first different size.

The present subject matter is further described in the following non-limiting examples.

### Example 1

### Completing an Incomplete Open-Bigram Sequence by Serial Order Sensorial Discrimination and Sensory Motor Insertion of Missing Different Open-Bigram Terms

The goal of the present exercises of Example 1 is to exercise the accurate sensorial discrimination and fast sensory motor insertion of a number of missing different open-bigram terms into their correct ordinal positions within an incomplete serial order of different open-bigram terms having the same spatial and time perceptual related attributes to form a complete alphabetical serial order of different open-bigram terms. In a non-limiting embodiment of the present exercises, a number of missing different open-bigram terms are required to be inserted into their correct direct alphabetical or inverse alphabetical serial order positions in an incomplete direct alphabetical (A-Z) or incomplete inverse alphabetical (Z-A) open-bigrams sequence. At the end of a successful different open-bigram terms sensorial discriminations and sensory motor insertions exercise, the subject ends up with a complete alphabetical serial order of different open-bigram terms with the same spatial and time perceptual related attributes, particularly a complete direct alphabetical or complete inverse alphabetical serial order of open-bigram terms, defined as direct alphabetic or inverse alphabetic open-bigram set arrays.

In a particular non-limiting embodiment of the present exercises, the subject is required to sensorially discriminate and sensory motor insert a number of uppercase missing different open-bigram terms in their correct alphabetical ordinal positions in an incomplete direct alphabetic open-bigram set array or in an incomplete inverse alphabetic open-bigram set array. Specifically, the exercises comprise the display of three sequential block exercises, each comprising two trial exercises. For example, each block exercise first trial exercise could display an incomplete direct alphabetic open-bigram set array followed immediately by a second trial exercise displaying an incomplete inverse alphabetic open-bigram set array (this exercise contemplates the completion of six incomplete alphabetic open-bigram set arrays). Accordingly, in each block exercise, both types of incomplete alphabetic open-bigram set arrays, namely, an incomplete direct alphabetic open-bigram set array type and an incomplete inverse alphabetic open-bigram set array type are generated and provided to the subject.

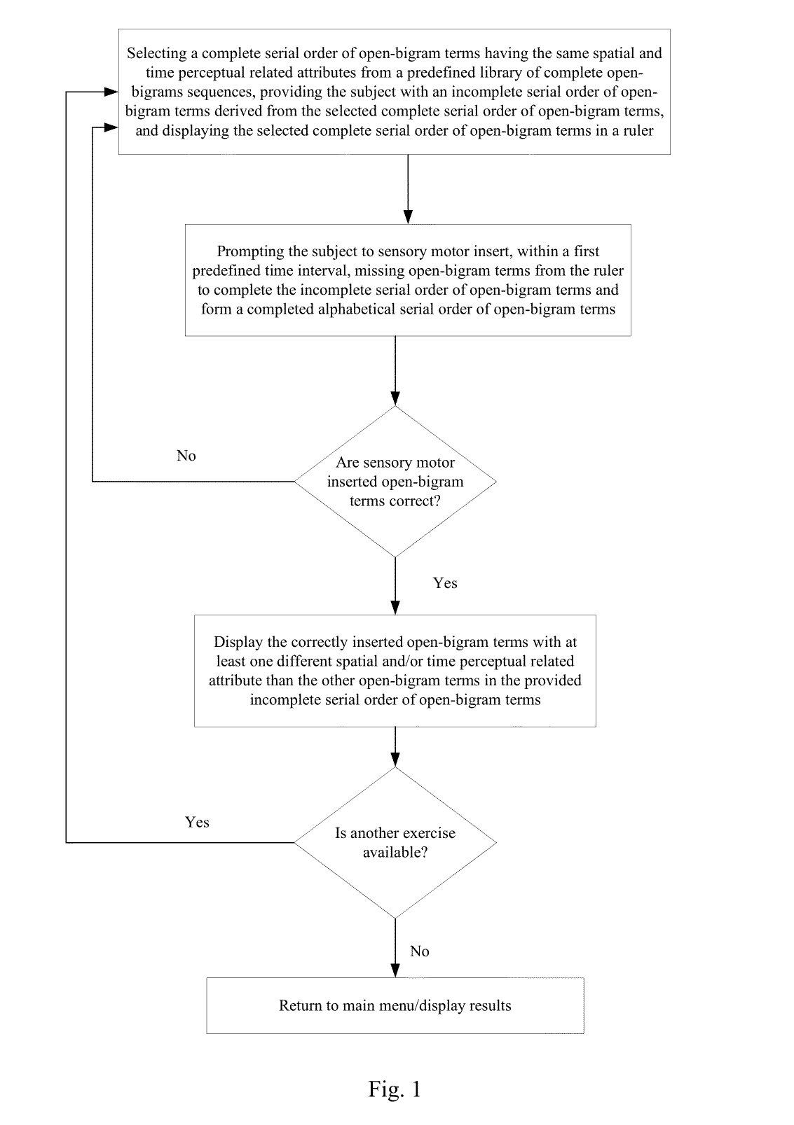

FIG. 1 is a flow chart setting forth the method that the present exercises use in promoting fluid intelligence abilities in a subject by the reasoning strategies the subject utilizes in order to sensorially discriminate and sensory motor insert missing different open-bigram terms (one at a time) into an incomplete serial order of different open-bigram terms to form a completed alphabetical serial order of different open-bigram terms. As can be seen in FIG. 1, the method of promoting fluid intelligence reasoning ability in the subject comprises selecting a complete serial order of different open-bigram terms having the same spatial and time perceptual related attributes from a predefined library of complete different open-bigram sequences, and providing the subject with an incomplete serial order of different open-bigram terms from the selected complete serial order of different open-bigram terms. This selected complete serial order of different open-bigram terms is graphically provided as a ruler to the subject. The subject is then prompted to sensorially discriminate and sensory motor insert, within a first predefined time interval, missing different open-bigram terms from the given complete array of different open-bigrams terms displayed in the ruler to complete the incomplete serial order of different open-bigram terms and form a completed alphabetical serial order of different open-bigram terms. If at least one different open-bigram term sensorial discrimination and sensory motor insertion made by the subject is an incorrect different open-bigram term sensory motor insertion, then the subject is returned to the step of selecting a complete serial order of different open-bigrams terms having the same spatial and time perceptual related attributes. If the different open-bigram term sensorial discriminations and sensory motor insertions made by the subject are all correct different open-bigram term sensory motor insertions, then all of the correctly sensory motor inserted different open-bigram terms are displayed with at least one different spatial or time perceptual related attribute than the rest of the different open-bigram terms in the alphabetical complete different open-bigrams sequence.

The above steps of the method are repeated for a predetermined number of iterations separated by one or more predefined time intervals, and upon completion of the predetermined number of iterations, the subject is provided with the results of each iteration. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

In another aspect of Example 1, the method of promoting fluid intelligence reasoning ability in a subject is implemented through a computer program product. In particular, the subject matter in Example 1 includes a computer program product for promoting fluid intelligence reasoning ability in a subject, stored on a non-transitory computer-readable medium which when executed causes a computer to perform a method. The method executed by the computer program on the non-transitory computer readable medium comprises selecting a serial order of different open-bigram terms having the same spatial and time perceptual related attributes, from a predefined library of complete different open-bigrams sequences, and providing the subject with an incomplete serial order of different open-bigram terms from the selected complete serial order of different open-bigram terms. The selected complete serial order of different open-bigram terms is graphically provided as a ruler to the subject. The subject is then prompted to sensorially discriminate and sensory motor insert, within a first predefined time interval, missing different open-bigram terms from the given array of different open-bigram terms shown in the ruler to complete the given incomplete serial order of open-bigram terms and form a completed alphabetical serial order of different open-bigram terms.

If at least one different open-bigram term sensorial discrimination and sensory motor insertion made by the subject is an incorrect different open-bigram term sensorial discrimination and sensory motor insertion, then the subject is returned to the step of selecting a complete serial order of different open-bigram terms having the same spatial and time perceptual related attributes. If the different open-bigram term sensorial discriminations and sensory motor insertions made by the subject are all correct open-bigram term sensory motor insertions, then all of the correctly sensory motor inserted different open-bigram terms are displayed with at least one different spatial or time perceptual related attribute than the rest of the different open-bigram terms in the completed different open-bigrams sequence. The above steps of the method are repeated for a predetermined number of iterations separated by second predefined time intervals, and upon completion of the predetermined number of iterations, the subject is provided with the results of each iteration.

In a further aspect of Example 1, the method of promoting fluid intelligence reasoning ability in a subject is implemented through a system. The system for promoting fluid intelligence reasoning ability in a subject comprises: a computer system comprising a processor, memory, and a graphical user interface (GUI), the processor containing instructions for: providing the subject with an incomplete direct or inverse alphabetic open-bigram sequence on the GUI, obtained from a previously selected complete set array of a predefined library of complete different open-bigram sequences; the selected complete open-bigram set array provided graphically as a ruler to the subject; prompting the subject on the GUI to sensorially discriminate and sensory motor insert missing different open-bigram terms (one at a time) from the given array of different open-bigram terms shown in the ruler to complete the incomplete direct or inverse alphabetic open-bigram sequence; if at least one different open-bigram term sensorial discrimination and sensory motor insertion made by the subject is an incorrect different open-bigram term sensory motor insertion, then returning to the step of providing the subject with an incomplete direct or inverse alphabetic open-bigram sequence on the GUI; if the different open-bigram term sensorial discriminations and sensory motor insertions made by the subject are all correct open-bigram term sensory motor insertions, then displaying on the GUI the complete direct or inverse alphabetic open-bigram set array with all of the correctly sensorially discriminated and sensory motor inserted open-bigram terms being displayed with at least one different spatial or time perceptual related attribute than the rest of the different open-bigram terms in the completed different open-bigrams sequence; repeating the above steps for a predetermined number of iterations; and upon completion of the predetermined number of iterations, providing the subject with the results of each iteration on the GUI.

In general, the exercises of Example 1 require the subject to sensorially discriminate and sensory motor insert a number of missing different open-bigram terms in an incomplete serial order of different open-bigram terms to form a complete alphabetical serial order of different open-bigram terms. The first step in the method of the present example is to provide the subject with an incomplete serial order of different open-bigram terms from the selected complete serial order of different open-bigram terms. In an embodiment, the complete serial order of different open-bigram terms is selected from the group consisting of direct alphabetic open-bigram set array, direct type of alphabetic open-bigram set array, and direct central type of alphabetic open-bigram set array, where the number of different open-bigram terms missing in the derived incomplete direct alphabetical serial order of different open-bigram terms comprises 2-7 different open-bigram terms.

Likewise, if the complete serial order of different open-bigram terms is selected from the group consisting of inverse alphabetic open-bigram set array, inverse type of alphabetic open-bigram set array, and inverse central type of alphabetic open-bigram set array, the number of different open-bigram terms missing in the derived incomplete inverse alphabetical serial order of different open-bigram terms comprises 2-5 different open-bigram terms.

In a particular non-limiting embodiment, in order to successfully complete an incomplete direct or inverse alphabetic open-bigram sequence, the subject is required to visually serially search, click-select and drag (when using a computer) one different open-bigram term at a time with the hand-held mouse device from a complete alphabetic open-bigram set array displayed as a ruler underneath the incomplete different open-bigrams sequence and sensorially discriminate and sensory motor insert the correct different open-bigram term, as fast as possible, in its correct alphabetical ordinal position in the displayed incomplete different open-bigrams sequence.

The subject is given a predefined time interval within which the subject must validly perform the trial exercises. If the subject for whatever reason does not perform the trial exercise within this predefined time interval, also referred to as “a valid performance time period”, then after a delay, which could be of about 4 seconds, the next in-line incomplete different open-bigrams sequence type trial exercise for the subject to perform is displayed. In embodiments, this predefined time interval or valid performance time period, herein representing the maximal allowed time for a subject's lack of sensory motor response, is defined to be 10-60 seconds, in particular 20-40 seconds, and further specifically 22 seconds.

In the present Example 1, there are predefined time intervals between block exercises. Let Δ1 herein represent a time interval between block exercises' performances of the present task, where Δ1 is herein defined to be of 8 seconds. However, other time intervals are also contemplated, including without limitation, 5-15 seconds and the integral times there between.

As previously discussed, upon sensorial discrimination and sensory motor insertion of the correct missing different open-bigram terms by the subject, the completed direct or inverse alphabetic open-bigram set array is then displayed with the correct sensory motor inserted different open-bigram terms being displayed with at least one different spatial and/or time perceptual related attribute than the spatial or time perceptual related attributes of the open-bigram terms in the originally provided incomplete direct or inverse alphabetic open-bigram sequence.

The changed spatial or time perceptual related attribute of the correct different open-bigram term answer is selected from the group consisting of spatial and/or time perceptual related attributes or combinations thereof. In particular, the changed spatial and/or time perceptual related attribute is selected from the group including open-bigram term font color, open-bigram term font size, open-bigram term font style, open-bigram term font spacing, open-bigram term font case, open-bigram term font boldness, open-bigram term font angle rotation, open-bigram term font mirroring, or combinations thereof. Furthermore, the correctly sensory motor selected open-bigram terms may also be displayed with a time perceptual related attribute font flickering behavior in order to further highlight the differences in open-bigram term spatial or time perceptual related attributes.

In a particular aspect of the present example, the change in spatial and/or time perceptual related attributes is made according to predefined correlations between spatial and time perceptual related attributes and the ordinal position of those different open-bigram terms in the selected complete serial order of different open-bigram terms in the first step of the method. For the case of a subject's visual perception of a complete direct alphabetic open-bigram set array of the English alphabetical language, the first ordinal position (occupied by the different open-bigram term “AB”), will generally appear towards the left side of his/her field of vision, whereas the last ordinal position (occupied by the different open-bigram term “YZ”) will appear towards his/her right field of vision. For a non-limiting example of these predefined correlations, if the ordinal position of the different open-bigram term for which a spatial and/or time perceptual related attribute will be changed falls in the left field of vision, the change in spatial and/or time perceptual related attribute may be different than if the ordinal position of the different open-bigram term for which the spatial or time perceptual related attribute will be changed falls in the right field of vision.

In this non-limiting example, if the spatial and/or time perceptual related attribute of the different open-bigram term to be changed is the font color, and if the ordinal position of that different open-bigram term falls in the left field of vision, then the font color will be changed to a first different color, while if the ordinal position of the different open-bigram term falls in the right field of vision, then the font color will be changed to a second font color different from the first font color. Likewise, if the spatial and/or time perceptual related attribute of the different open-bigram term to be changed is the font size, then the different open-bigram terms with an ordinal position falling in the left field of vision will be changed to a first different font size, while the different open-bigram terms with an ordinal position falling in the right field of vision will be changed to a second different font size that is also different than the first different font size.

Further, the exercises in Example 1 are useful in promoting fluid intelligence abilities in the subject by grounding root core fluid inductive-deductive cognitive abilities in selective goal oriented motor activity that occurs when the subject reasons in order to problem solve and perform the given serial orders of different open-bigram terms exercises. That is, the subject's reasoning in order to sensorially discriminate and/or sensory motor manipulate serial orders of different open-bigrams terms (also numerical and alphanumeric different open-bigrams serial orders) engages goal oriented motor activity within the subject's body. The goal oriented motor activity engaged within the subject may be any goal oriented motor activity involved in the group consisting of: sensorial perception of the selected complete and incomplete serial orders of different open-bigram terms, goal oriented body movements executed when sensory motor selecting and dragging the missing different open-bigram terms from the ruler, and combinations thereof. While any goal oriented body movements can be considered body sensory motor activity within the subject, the present subject matter is concerned with goal oriented body movements selected from the group consisting of goal oriented body movements of the subject's eyes, head, neck, arms, hands, fingers, and combinations thereof.

By requesting that the subject engage in various degrees of goal oriented body motor activity, the exercises of Example 1 are requiring the subject to bodily-ground root core cognitive fluid intelligence abilities as discussed above. The exercises of Example 1 bring the subject back to revisit an early developmental realm where he/she implicitly experienced an efficient enactment of root core fluid cognitive abilities, principally inductive reasoning abilities when specifically performing serial pattern recognition of non-concrete open-bigram terms and unitary letter symbols meshing with their salient spatial-time perceptual related attributes. The developmental established relationships between these non-concrete terms/symbols and their salient spatial-time perceptual related attributes heavily promote symbolic knowhow in a subject. By doing this, the exercises of Example 1 strengthen the ability to sensorially serially search, identify and sensory motor insert the correct missing different open-bigram terms in relevant incomplete different open-bigram sequences via novel reasoning strategies set forward by the subject in order to quickly and efficiently problem solve the exercises of Example 1. It is important that the exercises of Example 1 accomplish novel reasoning strategies for problem solving selective serial orders of different open-bigram terms by downplaying or mitigating the subject's need to recall-retrieve and use verbal semantic or episodic memory knowledge in order to support and/or assist his/her novel reasoning strategies as much as possible.

The exercises of Example 1 are mainly within promoting fluid intelligence abilities in general and novel inductive reasoning strategies in particular in a subject, but these exercises do not operationally rise to a learning level capable of promoting crystallized intelligence narrow abilities mainly via explicit associative learning supported by declarative semantic knowledge. As such, in predefined libraries of complete different open-bigram sequences, a specific alphabetical open-bigram type sequence and complete serial orders of different open-bigram terms are selected, to specifically downplay or mitigate the subject's need for developing problem solving strategies and/or drawing inductive-deductive inferences necessitating verbal knowledge and/or recall-retrieval of information from declarative-semantic and/or episodic kinds of memories.

In an aspect of the exercises presented in Example 1, the library of complete different open-bigram sequences includes the following alphabetic open-bigram sequences as defined above: direct alphabetic open-bigram set array; inverse alphabetic open-bigram set array; direct type of alphabetic open-bigram set array; inverse type of alphabetic open-bigram set array; central type of alphabetic open-bigram set array; and, inverse central type alphabetic open-bigram set array. It is understood that the above library of complete alphabetic open-bigram sequences may contain additional open-bigram set array sequences or fewer open-bigram set array sequences than those listed above.

Furthermore, it is also important to consider that the exercises of Example 1 are not limited to serial orders of alphabetic open-bigram sequences. It is also contemplated that the exercises are also useful when numeric serial orders and/or alpha-numeric serial orders are used within the exercises. In other words, while the specific examples set forth employ serial orders of different open-bigram terms, it is also contemplated that serial orders comprising numbers and/or alpha-numeric different open-bigram terms can be used.

In an aspect of the present subject matter, the exercises of Example 1 include providing a graphical representation of a complete open-bigrams sequence, in a ruler shown to the subject, when providing the subject with an incomplete direct or inverse alphabetical open-bigrams sequence. In a subject, the visual presence of the ruler facilitates a less demanding visual spatial attentional performance of the exercise. Accordingly, the presence of the ruler enables a faster and accurate visual recognition of the missing and non-missing different open-bigram terms in the incomplete open-bigrams sequence, and consequentially a faster sensory motor insertion of a number of missing different open-bigram terms into their correct direct alphabetical or inverse alphabetical serial order positions in an incomplete direct alphabetic (A-Z) or incomplete inverse alphabetic (Z-A) open-bigram sequence is to be expected. In summary, it is to be expected that the graphical representation and display of a complete direct or inverse alphabetic set array of open-bigram terms in a ruler facilitates the subject's efficiency in completing the required to perform open-bigram sequences. In the present exercises, the ruler comprises one of a plurality of open-bigram sequences in the above disclosed library of complete open-bigram sequences, namely direct alphabetic open-bigram set array; inverse alphabetic open-bigram set array; direct type of alphabetic open-bigram set array; inverse type of alphabetic open-bigram set array; central type of alphabetic open-bigram set array; and inverse central type alphabetic open-bigram set array.

The methods implemented by the exercises of Example 1 also contemplate those situations in which the subject fails to perform the given task. The following failing to perform criteria is applicable to any trial exercise in any block exercise of the present task in which the subject fails to perform for whatever reason. Specifically, for the present exercises, there are two kinds of “failure to perform” criteria. The first kind of “failure to perform” criteria occurs in the event the subject fails to perform by not sensory motor click-selecting (that is, the subject remains inactive/passive) with the hand-held mouse device on the valid or not valid next open-bigram term answer choice displayed (among 4 open-bigram term answer choices), within a predefined valid performance time period, then after a delay, which could be of about 4 seconds, the next in-line open-bigram sequence type trial exercise for the subject to perform is displayed.

The second “failure to perform” criteria is in the event the subject fails to perform by the sensory motor insertion of an incorrect different open-bigram term. More so, as an operational rule applicable for any failed trial exercise of the present task, failure to perform results in the automatic displaying of the next in-line required to perform open-bigram sequence type in its respective trial exercise for the subject to sensorially discriminate and sensory motor insert the missing different open-bigram terms into the incomplete direct or inverse alphabetic open-bigram sequence. However, in the event the subject fails to correctly sensorially discriminate and sensory motor insert the proper missing different open-bigram term inside the required to perform open-bigram sequence in excess of 2 consecutive wrong different open-bigram terms answers (in a single trial exercise in a single block exercise), then one of the following two options will occur: 1) if the failure to perform is for more than 2 consecutive wrong different open-bigram term answers (in a single trial exercise of Example 1), then the subject's current trial exercise performance is immediately halted and after a time interval of about 4 seconds, the next in-line required to perform incomplete open-bigram sequence type in its respective trial exercise will immediately be displayed (for the subject to perform) or in the next in-line block exercise; or 2) (which is only relevant for the last block exercise of Example 1) if the subject is failing to perform trial exercise #2 in block exercise #3, it will be immediately exited from the remainder of the third block exercise, and returned back to the main menu of the computer program.

The total duration to complete the exercises of Example 1, as well as the time it took to implement each one of the individual trial exercises, is registered in order to help generate an individual and age-gender related performance score. Performance records of all missing different open-bigram term answers for all types open-bigram sequences displayed are also generated. In general, the subject will perform this task about 6 times during his/her language based brain neuroperformance-fitness training program.

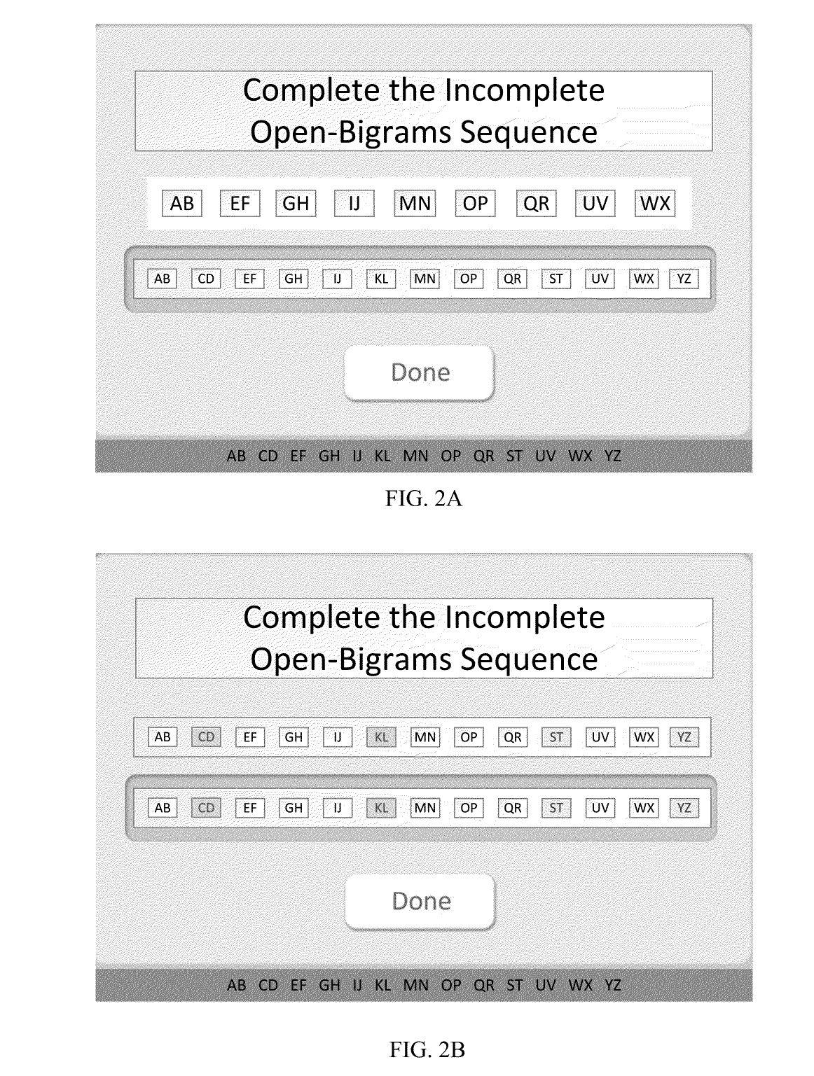

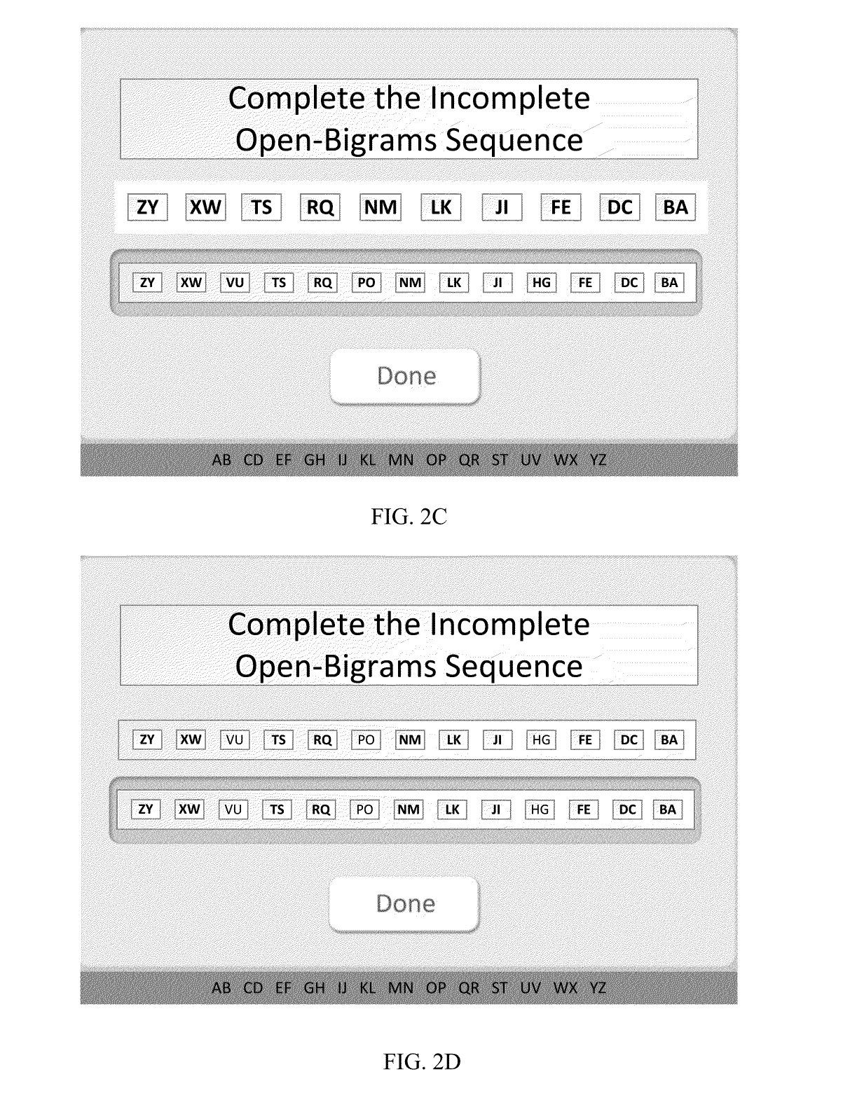

FIGS. 2A-2D depict a number of non-limiting examples of the exercises for sensorially discriminating and sensory motor inserting missing different open-bigram terms in an incomplete serial order of different open-bigram terms. FIG. 2A shows an incomplete direct alphabetical serial order of different open-bigram terms, along with the complete direct alphabetic open-bigram set array of different bigram terms underneath the incomplete serial order of different open-bigram terms. The subject is then prompted to complete the incomplete direct alphabetical serial order of different open-bigram terms by sensorially discriminating and sensory motor inserting the missing different open-bigram terms one at a time. FIG. 2B shows the completed direct alphabetical serial order of different open-bigram terms with the correct sensorially discriminated and sensory motor inserted missing different open-bigram terms being displayed with a single changed time perceptual related attribute. In this exercise, the correct sensorially discriminated and sensory motor inserted missing different open-bigram terms (CD, KL, ST and YZ) have a changed time perceptual related attribute font color.

While the exercise depicted in FIGS. 2A and 2B shows the correct sensorially discriminated and sensory motor inserted missing different open-bigram terms having a changed time perceptual related attribute in the form of a font color change, it is understood that any previously discussed spatial or time perceptual related attribute could be changed in lieu of, or in addition to, the changed time perceptual related attribute font color. The subject matter of Example 1 contemplates that up to 7 different spatial-time perceptual related attributes could be changed among the various correct sensorially discriminated and sensory motor inserted missing different open-bigram terms. Furthermore, it should also be understood that, while the exercise in FIGS. 2A and 2B depict an exercise in which 4 different open-bigram terms were missing from the incomplete direct alphabetical serial order of different open-bigram terms, any number from 2-7 of different open-bigram terms could have been missing.

Likewise, FIG. 2C shows an incomplete inverse alphabetical serial order of different open-bigram terms along with the complete inverse alphabetic open-bigram set array there under. In some embodiments, all of the different open-bigram terms from an incomplete inverse alphabetical serial order of different open-bigram terms can be displayed with a single changed spatial perceptual related attribute. In this exercise, all of the different open-bigram terms of the displayed incomplete inverse alphabetical serial order of different open-bigram terms have a change spatial perceptual related attribute font boldness. The subject is then prompted to complete the inverse alphabetical serial order of open-bigram terms by sensorially discriminating and sensory motor inserting the correct missing different open-bigram terms one at a time.

FIG. 2D shows the completed inverse alphabetical serial order of different open-bigram terms with the correct sensorially discriminated and sensory motor inserted missing different open-bigram terms being displayed with a single changed spatial perceptual related attribute. In this exercise, the correct sensorially discriminated and sensory motor inserted missing different open-bigram terms (VU, PO, and HG) have changed spatial perceptual related attribute open-bigram font boldness. While the exercise depicted in FIGS. 2C and 2D shows the correct sensorially discriminated and sensory motor inserted missing different open-bigram terms having only changed spatial perceptual related attribute font boldness, it is understood that any previously discussed spatial or time perceptual related attribute could be changed in lieu of, or in addition to, the changed spatial perceptual related attribute different open-bigram term font boldness. The subject matter of Example 1 contemplates that up to 7 different spatial and/or time perceptual related attributes could be changed among the various correctly sensorially discriminated and sensory motor inserted missing different open-bigram terms. Furthermore, it should also be understood that, while the exercise in FIGS. 2C and 2D depict an exercise in which 3 different open-bigram terms were missing from the incomplete inverse alphabetical serial order of open-bigram terms any number from 2-5 different open-bigram terms could have been missing.

### Example 2

### Completing a Direct or Inverse Alphabetical Open-Bigram Sequence with Two or More Alphabetically Contiguous Incomplete Open-Bigram Sequences

In a particular embodiment of the present exercises, the subject is required to exercise his/her ability to quickly visually recognize a selected incomplete alphabetical open-bigram sequence that can become a complete direct or inverse alphabetic open-bigram set array, if in a number of steps it is completed by one or two contiguous incomplete open-bigram sequences, wherein all of the open-bigram terms in the completed direct or inverse alphabetic open-bigram set array have the same spatial and time perceptual related attributes. Specifically, a plurality of incomplete direct alphabetical open-bigram sequences (A-Z) or incomplete inverse alphabetical open-bigram sequences (Z-A) are selected and provided to the subject. In this context, none of these incomplete open-bigram sequences will comprise all of the possible 13 different open-bigram terms of the direct or inverse alphabetic open-bigram set arrays of the English alphabetical language.

The goal of the present exercises is for the subject to rapidly visually serially search and effectively sensorially recognize the ordinal positions corresponding to the different open-bigram terms entailing these incomplete direct or inverse alphabetical open-bigram sequences. In relation to one provided incomplete alphabetic letter open-bigram sequence, the subject should quickly sensorially discriminate and sensory motor select two or more alphabetically contiguous incomplete direct or inverse alphabetical open-bigram sequences, from a given pull comprising the selected incomplete open-bigram sequences, to complete the provided incomplete alphabetic open-bigram sequence, and in a number of steps, attain a complete direct or inverse alphabetical open-bigram sequence (a direct alphabetic or an inverse alphabetic open-bigram set array).

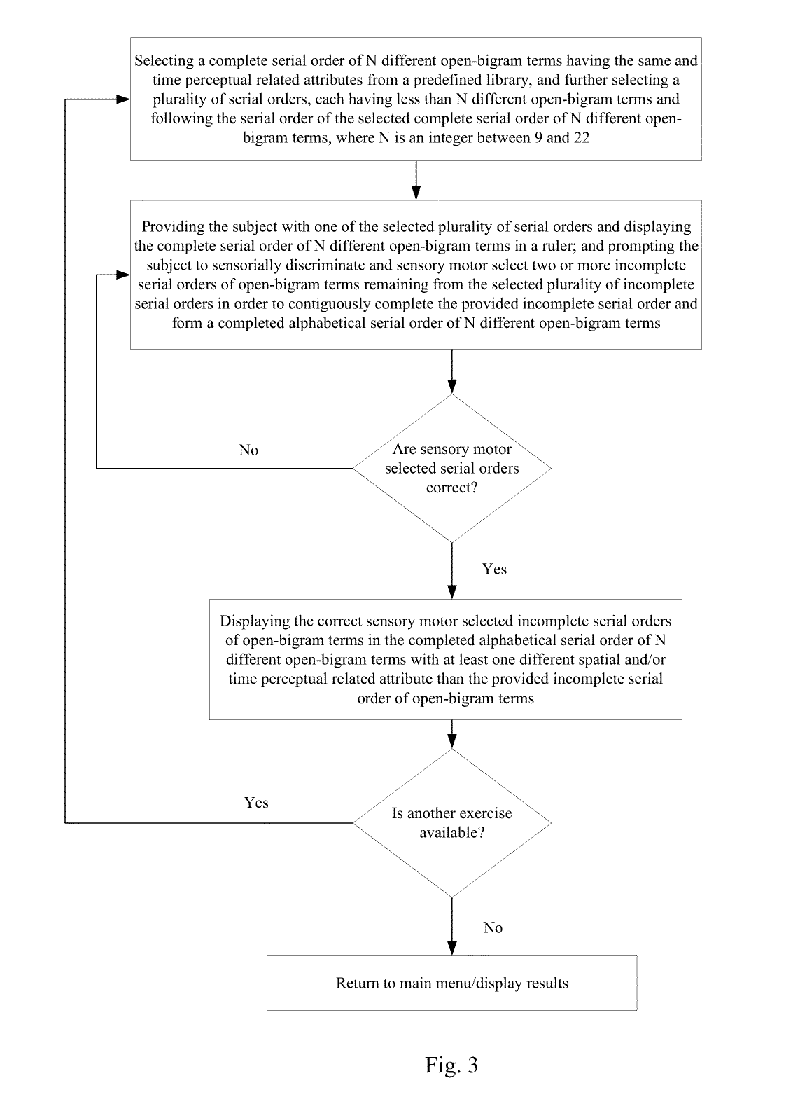

FIG. 3 is a flow chart setting forth the method that the present exercises use in promoting fluid intelligence abilities in a subject by completing an incomplete serial order of different open-bigram terms to form a completed alphabetical serial order of different open-bigrams sequence (e.g., alphabetic or numeric or alphanumeric symbols). As can be seen in FIG. 3, the method of promoting fluid intelligence abilities in the subject comprises first selecting a serial order of different open-bigram terms from a predefined library of complete open-bigram sequences, where the first selected serial order of different open-bigram terms entails N different open-bigrams terms having the same spatial or time perceptual related attributes, and from this selection further selecting a plurality of incomplete open-bigram sequences entailing serial orders of different open-bigram terms with less than N consecutive different open-bigram terms.

In a non-limiting example (e.g., English alphabetical language and integer numbers 1 to 9) N could be an integer between 9 and 22. The subject is then provided with one open-bigram sequence entailing an incomplete serial order of different open-bigram terms from the selected plurality of incomplete serial orders of different open-bigram terms. The subject is prompted to sensorially discriminate and sensory motor select, within a first predefined time interval, two or more incomplete serial orders of different open-bigram terms among the remaining incomplete serial orders of different open-bigram terms of the selected plurality of incomplete serial orders of different open-bigram terms, in order to gradually complete in a contiguous alphabetical manner the incomplete serial order of different open-bigram terms provided in the previous step, to form a completed direct or inverse alphabetical serial order of open-bigram terms having the N different open-bigram terms of the complete open-bigrams sequence.

If at least one sensorial discrimination and sensory motor selection made by the subject is an incorrect sensorial discrimination and sensory motor selection of an incomplete serial order of different open-bigram terms, then the subject is returned to the step of being prompted to correctly sensorially discriminate and sensory motor select the one or more incomplete serial orders of different open-bigram terms. If the two or more sensorial discriminations and sensory motor selections made by the subject are all correct sensorial discriminations and sensory motor selections of incomplete serial orders of different open-bigram terms, the completed serial order of different open-bigrams sequences is displayed, wherein the two or more correct sensorially discriminated and sensory motor selected incomplete serial orders of different open-bigram terms are displayed with at least one different spatial and/or time perceptual related attribute than the spatial and/or time perceptual related attributes in the provided incomplete serial order of different open-bigram terms.

The above steps of the method are repeated for a predetermined number of iterations separated by one or more predefined time intervals, and upon completion of the predetermined number of iterations, the subject is provided with the results of each iteration. The predetermined number of iterations can be any number needed to establish that a satisfactory reasoning performance concerning the particular task at hand is being promoted within the subject. Non-limiting examples of number of iterations include 1, 2, 3, 4, 5, 6, and 7. However, any number of iterations can be performed, like 1 to 23.

Another aspect of Example 2 is directed to the method of promoting fluid intelligence abilities in the subject on which this method is being implemented, through a computer program product. In particular, the subject matter in Example 2 includes a computer program product for promoting fluid intelligence abilities in a subject, stored on a non-transitory computer readable medium which when executed causes a computer system to perform a method. The method executed by the computer program on the non-transitory computer readable medium comprises selecting a serial order of different open-bigram terms from a predefined library of complete open-bigrams sequences with N different open-bigram terms having the same spatial or time perceptual related attributes, and further selecting a plurality of incomplete serial orders of different open-bigram terms with less than N different consecutive open-bigram terms from the selected serial order of different open-bigram terms.

In a non-limiting example N could be an integer between 9 and 22. The subject is then provided with one incomplete serial order of different open-bigram terms from the selected plurality of incomplete serial orders of different open-bigram terms. The subject is prompted to correctly sensorially discriminate and sensory motor select, within a first predefined time interval, two or more incomplete serial orders of different open-bigram terms among the remaining incomplete serial orders of different open-bigram terms of the selected plurality of incomplete serial orders of different open-bigram terms, in order to gradually alphabetically complete in a contiguous manner the provided incomplete serial order of different open-bigram terms in the previous step, to form a completed direct or inverse alphabetical serial order of open-bigram terms having N different open-bigram terms in the completed open-bigrams sequence.

If at least one sensorial discrimination and sensory motor selection made by the subject is an incorrect sensorial discrimination and sensory motor selection of an alphabetical contiguous incomplete serial order of different open-bigram terms, then the subject is returned to the step of being prompted to correctly sensorially discriminate and sensory motor select the two or more alphabetical contiguous incomplete serial orders of different open-bigram terms. If the two or more sensorial discriminations and sensory motor selections made by the subject are all correct sensorial discriminations and sensory motor selections of alphabetical contiguous incomplete serial orders of different open-bigram terms, the completed alphabetical serial order of different open-bigram terms is displayed, wherein the correct sensorially discriminated and sensory motor selected two or more alphabetical contiguous incomplete serial orders of different open-bigram terms are displayed with at least one different spatial and/or time related attribute than the spatial and/or time perceptual related attributes in the provided open-bigrams sequence entailing an incomplete serial order of different open-bigram terms. The above steps of the method are repeated for a predetermined number of iterations separated by one or more predefined time intervals, and upon completion of the predetermined number of iterations, the subject is provided with the results of each iteration.

In a further aspect of Example 2, the method of promoting fluid intelligence abilities in a subject is implemented through a system. The system for promoting fluid intelligence abilities in a subject comprises: a computer system comprising a processor, memory, and a graphical user interface (GUI), the processor containing instructions for: selecting a serial order of open-bigram terms from a predefined library of complete open-bigram sequences with N different open-bigram terms having the same spatial and time perceptual related attributes, and further selecting a plurality of incomplete serial orders of open-bigram terms with less than N different open-bigram terms, following the same serial order as the selected complete serial order of open-bigram terms, wherein N could be in a non-limiting example an integer between 9 and 22; providing the subject on the GUI with one incomplete open-bigrams sequence from the selected plurality of incomplete serial orders of different open-bigram terms; prompting the subject on the GUI to sensorially discriminate and sensory motor select, within a first predefined time interval, two or more incomplete serial orders of open-bigram terms among the remaining plurality of incomplete serial orders of open-bigram terms, to gradually complete in a contiguous alphabetical manner the provided incomplete open-bigrams sequence, in order to form a completed direct or inverse alphabetical serial order of open-bigram terms having N different open-bigram terms; if at least one sensory motor selection made by the subject incorrect, then returning to the step of prompting the subject on the GUI to correctly sensorially discriminate and sensory motor select two or more incomplete serial orders of open-bigram terms; if the two or more sensorial discriminations and sensory motor selections made by the subject are all correct, then displaying the completed direct or inverse alphabetical serial order of open-bigram terms on the GUI, wherein the correct sensorially discriminated and sensory motor selected two or more incomplete serial orders of open-bigram terms are displayed with at least one different spatial and/or time perceptual related attribute than the spatial and/or time perceptual related attributes of the originally provided to the subject incomplete serial order of open-bigram terms; repeating the above steps for a predetermined number of iterations separated by one or more predefined time intervals; and upon completion of the predetermined number of iterations, providing the subject with the results of each iteration on the GUI.

In an aspect of the exercises of Example 2, the first selection of one complete serial order of different open-bigram terms is done at random, from the predefined serial orders of complete open-bigram terms in the library, followed by a second selection of a plurality of incomplete serial orders of different open-bigram terms, also done at random, from the selected complete serial order of different open-bigram terms, by randomizing predefined ordinal positions of the open-bigram terms in the selected complete serial order of open-bigram terms. While this aspect of the exercises is easier to implement through the use of a computer program, it is also understood that the above first and second random selection of the serial order of different open-bigram terms, is also achievable manually.

The second selection step in the method of the present Example 2 is to provide the subject with a plurality of incomplete open-bigram sequences from the first selected complete serial order of open-bigram terms, wherein the serial order of different open-bigrams is conserved. In some embodiments, when the serial order of open-bigram terms in the first selection step is chosen from the group consisting of direct alphabetic open-bigram set array, direct type of alphabetic open-bigram set array, and central type of alphabetic open-bigram set array, the number of different open-bigram terms in the provided incomplete serial order of different open-bigram terms from the plurality of incomplete serial orders of different open-bigram sequences comprises 2-7 different open-bigram terms. In particular, the number of different open-bigram terms in the provided incomplete serial order of open-bigram terms in these non-limiting example exercises is between three and five open-bigram terms.

Likewise, when the complete serial order of different open-bigram terms in the first step is selected from the group consisting of inverse alphabetic open-bigram set array, inverse type of alphabetic open-bigram set array, and inverse central type of alphabetic open-bigram set array, the number of different open-bigram terms in the provided one incomplete serial order of open-bigram terms from the plurality of incomplete serial orders of open-bigram terms comprises 2-5 open-bigram terms. In one particular embodiment, the number of open-bigram terms in the provided incomplete inverse serial order of open-bigram terms is between three and four different open-bigrams terms.

Furthermore, the above mentioned plurality of incomplete serial orders of open-bigram terms is displayed for their possible use in alphabetically contiguously completing the one provided incomplete serial order of open-bigram terms. The number of incomplete serial orders of different open-bigram terms provided to the subject for possible use in alphabetically contiguously completing the provided incomplete serial order of open-bigram terms is 8-16 incomplete serial orders of different open-bigram terms. In some embodiments, the number of incomplete serial orders of open-bigram terms in the selected pool of incomplete open-bigram sequences for the subject's further sensorial discrimination and sensory motor selection is 10-12 incomplete different open-bigram sequences.

The pool of incomplete serial orders of different open-bigram terms displayed to the subject is the plurality of incomplete serial orders of different open-bigram terms from where the subject sensorially discriminates and sensory motor selects in order to alphabetically contiguously complete the provided incomplete serial order of open-bigram terms. In an embodiment, each of the plurality of incomplete serial orders of open-bigram terms that the subject sensorially discriminates and sensory motor selects to alphabetically contiguously complete the incomplete serial order of open-bigram terms comprises 4-12 incomplete different open-bigram sequences. In particular, the plurality of incomplete serial orders of open-bigram terms comprises 6-10 different open-bigrams sequences.

When the methods of Example 2 are implemented by a computer product program or a computer system, the computer product program can generate the one original complete serial order of different open-bigram terms, including both direct alphabetic and inverse alphabetic open-bigram set arrays, as well as the pool of incomplete serial orders of different open-bigram terms that will be displayed to the subject in order to correctly sensorially discriminate and sensory motor select two or more incomplete serial orders of open-bigram terms to alphabetically contiguously complete the provided incomplete serial order of open-bigram terms. In the alternative, the computer product program can be programmed to select the one serial order of different open-bigram terms, which is required to be alphabetically contiguously complete, from a library module. This library may also contain the plurality of incomplete serial orders of different open-bigram terms displayed to the subject in the exercises. Furthermore, it is contemplated that the library module storing various serial orders of different open-bigram terms can also store a multi-alphabetical-language library module, in which various serial orders of open-bigram terms represent alphabets of different spoken-written languages, which are stored and available for the computer product program to provide to the subject.

The subject is given a predefined time interval within which the subject must validly perform the exercises. If, for whatever reason, the subject does not perform the instant trial exercise within the predefined time interval, also referred to as “a valid performance time period,” then after a delay, which could be about 4 seconds, the next in-line incomplete different open-bigrams sequence type for the subject to perform is displayed. The maximal allowed time interval or valid performance time period for the subject's lack of sensory motor response is defined to be 10-60 seconds, in particular 20-40 seconds, and further specifically 22 seconds.

In the present Example 2, there is one or more predefined time intervals between block exercises. Let Δ1 herein represent a time interval between block exercises' performances of the present task, where Δ1 is herein defined to be of 8 seconds. However, other time intervals between block exercises are also contemplated, including without limitation, 5-15 seconds and the integral times there between.

As previously discussed, upon sensorial discrimination and sensory motor selection of the correct incomplete serial orders of different open-bigram terms by the subject, the alphabetically contiguous completed serial order of different open-bigram terms is then displayed with the alphabetically complementary contiguous serial orders of different open-bigram terms being displayed with at least one different spatial and/or time perceptual related attribute than the spatial and/or time perceptual related attributes of the originally provided incomplete serial order of different open-bigram terms. The changed spatial and/or time perceptual related attribute of the correct sensorially discriminated and sensory motor selected two or more incomplete serial orders of different open-bigram terms is selected from the group of spatial or time perceptual related attributes, or combinations thereof.

In a particular aspect, the changed spatial and/or time perceptual related attribute is selected from the group consisting of open-bigram term font color, open-bigram term sound, open-bigram term font size, open-bigram term font style, open-bigram term font spacing, open-bigram term case, open-bigram term font boldness, open-bigram term font rotation, open-bigram term font mirroring, or combinations thereof. Furthermore, all of the correct sensorially discriminated and sensory motor selected open-bigram terms may be displayed with a time perceptual related attribute font flickering behavior in order to further highlight differences in open-bigram term spatial and/or time perceptual related attributes.

In a particular aspect of the present Example 2, the change in spatial and/or time perceptual related attributes is done according to predefined correlations between space and time perceptual related attributes and the ordinal position of those open-bigram terms in the selected complete serial order of different open-bigram terms in the first step of the method. For the case of a subject's visual perception of a complete direct alphabetic open-bigram set array of the English alphabetical language, the first ordinal position (occupied by the open-bigram term “AZ”), will generally appear towards the left side of his/her field of vision, whereas the last ordinal position (occupied by the open-bigram term “YZ”), will appear towards his/her right field of vision.

For a non-limiting example of these predefined correlations, if the ordinal position of the open-bigram term for which a spatial or time perceptual related attribute will be changed falls in the left field of vision, the changed attribute may be different than if the ordinal position of the open-bigram term falls in the right field of vision. In this non-limiting example, if the spatial and/or time perceptual related attribute to be changed is the font color of the open-bigram term, and if the ordinal position of the open-bigram term falls in the left field of vision, then the font color will be changed to a first different font color (different from the default font color), whereas if the open-bigram term falls in the right field of vision, then the font color will be changed to a second font color different from the first font color. Likewise, if the spatial and/or time perceptual related attribute to be changed is the font size of the open-bigram term being displayed, then those open-bigram terms with an ordinal position falling in the left field of vision will be changed to a first different font size (different from the default font size), while the open-bigram terms with an ordinal position falling in the right field of vision will be changed to a second different font size that is yet different than the first different font size.

Further, the exercises in Example 2 are useful in promoting fluid intelligence abilities in the subject by grounding its basic fluid cognitive abilities in selective goal oriented motor activity that occurs when the subject performs the given exercise. That is, the sensorial discriminating and sensory motor manipulating of the open-bigram terms by the subject engages goal oriented motor activity within the subject's body. The goal oriented motor activity engaged within the subject may be any goal oriented motor activity involved in the group consisting of: sensorial perception (e.g., visual, auditory, haptic, etc) of the selected incomplete different open-bigram sequences from a library of complete serial orders of different open-bigram terms, as well as in the further sensorial discrimination and sensory motor selection of the alphabetical contiguous incomplete serial orders of different open-bigram terms to form a complete serial order of different open-bigram terms, body goal oriented movements executed when sensory motor selecting and dragging the incomplete serial orders of different open-bigram terms with the finger/hand (touch screen) or hand held mouse device, the serial pattern recognition/awareness of spatial-time perceptual related attribute changes of the different open-bigram terms, and combinations thereof. While any body movements can be considered motor activity within the subject, the present subject matter is particularly concerned with body goal oriented movements selected from the sensory-motor group which includes goal oriented body movements of the subject's eyes, head, neck, arms, hands, fingers and combinations thereof.

By requesting that the subject engage in specific degrees of goal oriented motor activity, the exercises of Example 2 are requiring the subject to bodily-ground root core cognitive fluid intelligence abilities such as inductive reasoning as discussed above. The exercises of Example 2 cause the subject to revisit an early developmental realm where he/she implicitly experienced efficient enactment of root core fluid cognitive abilities when specifically performing problem solving involving serial pattern recognition of non-concrete terms/symbols meshing (at the same time) with their salient spatial-time perceptual related attributes. The established symbolic-motoric-perceptual-cognitive relationships between these non-concrete terms/symbols and their salient spatial and/or time perceptual related attributes heavily promote symbolic sequential related knowhow in a subject. By doing this, the exercises of Example 2 strengthen the subject's ability to rapidly and accurately serially sensorially discriminate, sensory motor select and perform goal oriented body movements in order to successfully manipulate the correct alphabetically contiguous incomplete serial orders of different open-bigram terms from the pull of incomplete different open-bigram sequences to complete and obtain a complete direct or inverse alphabetic open-bigram set array.

In general, the method of Example 2 encourages the subject to reason in novel ways in order to efficiently problem solve the exercises of Example 2. It is important that the exercises of Example 2 accomplish this by downplaying or mitigating the subject's need to recall-retrieve and use verbal semantic or episodic memory knowledge, as much as possible, in order to support or assist his/her novel reasoning ability to problem solve the exercises in Example 2. The exercises of Example 2 are mainly within promoting fluid intelligence abilities in general and novel inductive reasoning strategies concerning sensorial serial pattern recognition and alphabetical contiguous assembling of incomplete open-bigram sequences to obtain a complete direct or inverse alphabetical serial order of open-bigram terms, but the exercises of Example 2 do not operationally rise to a learning level of promoting crystallized intelligence narrow abilities mainly via an explicit learning strategy that generates deductions of the associative learning kind supported by declarative semantic knowledge. As such, the specific selected serial orders of different open-bigram terms as well as the sensorial discrimination and sensory motor selection of the alphabetical contiguous incomplete serial orders of open-bigram sequences to form the completed serial order of different open-bigram terms are selected to specifically downplay or mitigate the subject's need for developing problem solving strategies and/or drawing deductive-inductive inferences necessitating recall-retrieval of information from declarative-semantic and/or episodic kinds of memories.

In an aspect of the exercises presented in Example 2, the library of complete open-bigram sequences includes the following complete different open-bigram sequences as defined above: direct alphabetic open-bigram set array; inverse alphabetic open-bigram set array; direct type of alphabetic open-bigram set array; inverse type of alphabetic open-bigram set array; central type of alphabetic open-bigram set array; and, inverse central type alphabetic open-bigram set array. It is understood that the above library of complete different open-bigram sequences may contain additional different open-bigram set array sequences or fewer different open-bigram set array sequences than those listed above.

Furthermore, it is also important to consider that the exercises of Example 2 are not limited to serial orders with alphabetic open-bigram sequences. It is also contemplated that the exercises of Example 2 are also useful when numeric serial orders and/or alpha-numeric serial orders are used within the exercises. In other words, while the specific examples set forth employ serial orders of different open-bigrams terms, it is also contemplated that serial orders comprising different numerical and/or alpha-numeric open-bigram terms can also be used.

In an aspect of the present subject matter, the exercises of Example 2 include providing a graphical representation of the first selected direct or inverse alphabetical open-bigram set array in a ruler shown to the subject. The visual presence of the ruler facilitates the subject's visual attentional performance of the exercise. Accordingly, the presence of the ruler enables a more accurate visual recognition of the required direct alphabetic or inverse alphabetic open-bigram set array, and therefore, a faster completion of the first selected direct or inverse alphabetical open-bigram set array is to be expected. In summary, the ruler facilitates an efficient and faster sensorial discrimination and sensory motor completion of the required to perform direct or inverse alphabetic open-bigram set arrays by the subject.

In the present exercises, the ruler comprises one of a plurality of complete different open-bigram sequences in the above disclosed predefined library of complete different open-bigram sequences, which comprises direct alphabetic open-bigram set array; inverse alphabetic open-bigram set array; direct type of alphabetic open-bigram set array; inverse type of alphabetic open-bigram set array; central type of alphabetic open-bigram set array; inverse central type alphabetic open-bigram set array;

The methods implemented by the exercises of Example 2 also contemplate those situations in which the subject fails to perform the given task. The following failing to perform criteria is applicable to any trial exercise in any block exercise of the present task in which the subject fails to sensory motor perform for whatever reason. Specifically, for the present exercises, there are two kinds of “failure to perform” criteria. The first kind of “failure to perform” criteria occurs in the event the subject fails to sensory motor perform by not click-selecting and/or dragging (the subject remains sensory motor inactive/passive) with the hand-held mouse device on a valid or invalid complementary alphabetical contiguous incomplete serial order of different open-bigram terms answer choice displayed. If there is no sensory motor response within a predefined valid performance time period, the subject is returned to the beginning of the trial exercise to start over. In an embodiment, the valid performance time period for lack of response is defined to be 20-60 seconds, in particular 25-40 seconds, and further specifically 22 seconds. In the case of lack of sensory motor response, the subject will be provided with up to 3 additional new trial exercises. If failure to sensory motor perform within the valid performance time period take place consecutively within the 3 additional new trial exercises, the method provides that the subject will be transitioned to the next in-line second block exercise (if the failure to sensory motor perform occurred in the first block exercise), or the subject is returned to the main menu and the exercise is aborted if the failure to sensory motor perform occurs in the last block exercise, meaning during the subject sensory motor performance in the third block exercise.

The second kind of “failure to perform” criteria, is applicable in the event the subject fails to sensory motor perform by attempting to combine incorrect complementary alphabetically contiguous incomplete open-bigram sequences. In the event that the subject fails in any trial exercise of the present Example 2 because of selecting a wrong complementary alphabetical contiguous incomplete open-bigram sequence answer, the subject's wrong answer is immediately undone. The subject's incorrect complementary alphabetically contiguous open-bigram sequences answers are continuously and immediately undone until he/she correctly succeeds in sensorially discriminating and sensory motor selecting all of the required complementary alphabetically contiguous open-bigram sequences answers. Nevertheless, in the event the subject executes three consecutive wrong complementary alphabetically contiguous open-bigram sequences answers, the subject's performance of the current exercise ends and the next in-line exercise will commence after a time interval. If the three consecutive wrong complementary alphabetically contiguous open-bigram sequences answers are selected during the subject performance in the third block exercise, the block exercise is aborted and the subject is returned to the main menu.

The total duration to complete the exercises of Example 2, as well as the time it took to implement each one of the individual trial exercises, is recorded in order to help generate an individual or age-gender related performance score. Performance records of all wrong complementary alphabetically contiguous incomplete different open-bigram sequences answers for all types of complementary alphabetical contiguous different open-bigram sequences to be performed are also generated and displayed. In general, the subject will perform this task about 6 times during his/her language based brain neuroperformance-fitness training program.

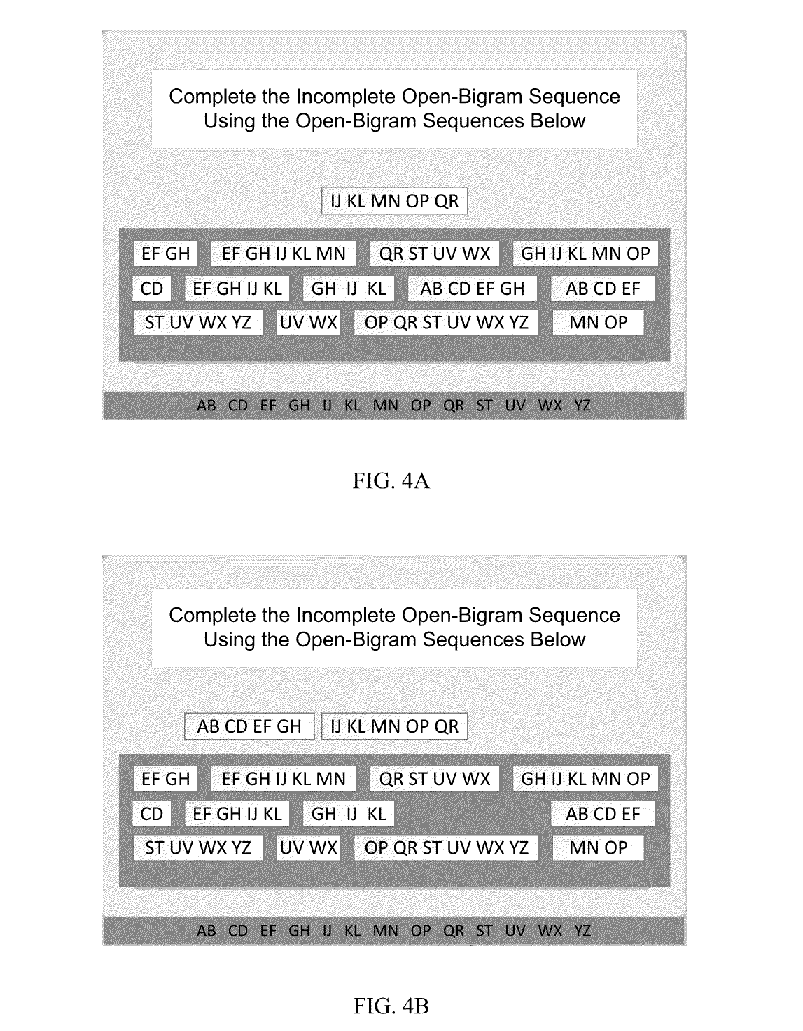

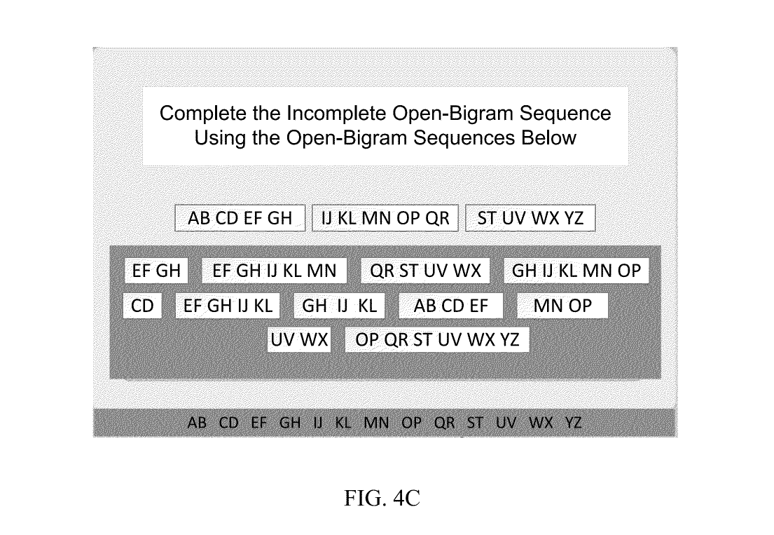

FIGS. 4A-4C depict a non-limiting example of the exercises completing an incomplete serial order of different open-bigram terms. FIG. 4A shows an originally selected incomplete direct alphabetical serial order of open-bigram terms, along with a number of other incomplete serial orders of different open-bigram terms provided there under. The original incomplete direct alphabetical serial order of open-bigram terms provided in FIG. 4A is IJ KL MN OP and QR. The subject is then prompted to complete the original incomplete direct alphabetical serial order of open-bigram terms by serially sensorially identifying and sensory motor selecting two or more of the complementary alphabetically contiguous serial orders of open-bigram terms. FIG. 4B shows that the subject has correctly sensorially identified one complementary alphabetically contiguous incomplete serial order of open-bigram terms, AB CD EF GH.

FIG. 4C shows the completed direct alphabetical serial order of open-bigram terms, with the subject having correctly sensorially identified the second complementary alphabetically contiguous serial order of open-bigram terms, ST UV WX YZ. In this exercise, although not shown in FIGS. 4B and 4C, the correct sensorially identified and sensory motor selected complementary alphabetically contiguous serial orders of open-bigram terms would be sensorially identified as being correct by having a changed spatial and/or time perceptual related attribute. The subject matter of Example 2 contemplates that up to a total of 7 different spatial and/or time perceptual related attributes could be changed among the various correctly sensorially identified and sensory motor inserted different open-bigram sequences, including any of the spatial and/or time perceptual related attributes previously discussed.

1. A method of promoting fluid intelligence abilities in a subject comprising:
a) selecting a serial order of an alphabetic open-bigram set array from a predefined library of complete alphabetic open-bigram sequences, wherein the open-bigram terms all have the same spatial and time perceptual related attributes; and providing the subject with an incomplete serial order of alphabetic open-bigram terms, obtained by subtracting a predefined number of terms from selected ordinal positions of the selected set array, and a ruler containing the selected serial order of the alphabetic open-bigram set array;
b) prompting the subject to sensorially discriminate and sensory motor insert missing open-bigram terms selected from the ruler in the provided incomplete serial order of alphabetic open-bigram terms, within a first predefined time interval, to form a completed serial order of alphabetic open-bigram terms from the selected set array;
c) if at least one sensory motor insertion of a missing open-bigram term obtained from the ruler made by the subject is an incorrect insertion, then returning to step b);
d) if the sensory motor insertions of all missing open-bigram terms obtained from the ruler made by the subject are all correct insertions, then displaying the correctly inserted missing open-bigram terms with at least one different spatial and/or time perceptual related attribute than the other open-bigram terms in the selected set array;
e) repeating the above steps for a predetermined number of iterations separated by one or more predefined time intervals; and
f) upon completion of the predetermined number of iterations, providing the subject with the results of each iteration.

2. The method of claim 1, wherein all of the open-bigram terms of the selected set array are different open-bigram terms.

3. The method of claim 1, wherein the library of complete alphabetic open-bigram sequences comprises a predefined number of alphabetic open-bigram set arrays, wherein each member of a set array is a single different open-bigram term, comprising: direct alphabetic open-bigram set array; inverse alphabetic open-bigram set array; direct type of alphabetic open-bigram set array; inverse type of alphabetic open-bigram set array; central type of alphabetic open-bigram set array; and inverse central type alphabetic open-bigram set array.

4. The method of claim 3, wherein the selected set array is selected from the group consisting of direct alphabetic open-bigram set array, direct type of alphabetic open-bigram set array, and central type of alphabetic open-bigram set array, and where 2-7 open-bigram terms are missing in the provided incomplete serial order of alphabetic open-bigram terms.

5. The method of claim 4, wherein the number of missing open-bigram terms in the provided incomplete serial order of alphabetic open-bigram terms is between 3 and 5.

6. The method of claim 3, wherein the selected set array is selected from the group consisting of inverse alphabetic open-bigram set array, inverse type of alphabetic open-bigram set array, and inverse central type of alphabetic open-bigram set array, and where 2-5 open-bigram terms are missing in the provided incomplete serial order of alphabetic open-bigram terms.

7. The method of claim 6, wherein the number of missing open-bigram terms in the provided incomplete serial order of alphabetic open-bigram terms is 3 or 4.

8. The method of claim 1, wherein the at least one different spatial and/or time perceptual related attribute of step d) is selected from one or more spatial perceptual related attributes including: open-bigram term font size, open-bigram term font style, open-bigram term font spacing, open-bigram term font case, open-bigram term font boldness, open-bigram term font angle rotation, and open-bigram term font mirroring; and/or one or more time perceptual related attributes including: open-bigram term font color, intermittent display of an open-bigram term at a predefined frequency, and motion of an open-bigram term at a predefined speed across a visual field of the subject.

9. The method of claim 1, wherein the at least one different spatial and/or time perceptual related attribute of step d) is selected according to a predefined relationship between the spatial and/or time perceptual related attributes and the ordinal position of the open-bigram terms in the selected set array.

10. The method of claim 9, wherein the at least one different spatial and/or time perceptual related attribute of step d) depends on whether the correct sensory motor inserted open-bigram term falls in a right or a left visual field of the subject in accordance with the ordinal position of the inserted open-bigram term in the completed serial order of alphabetic open-bigram terms from the selected set array.

11. The method of claim 1, wherein the sensorial discriminations and sensory motor insertions of missing open-bigram terms obtained from the ruler by the subject engage goal oriented motor activity within a body of the subject, the goal oriented motor activity selected from the sensory-motor group including: sensorial perception of the completed and incomplete serial orders of alphabetic open-bigram terms, goal oriented body movements to execute the sensorial discrimination and sensory motor insertion of the open-bigram terms, and combinations thereof.

12. The method of claim 11, wherein the goal oriented body movements are selected from the group consisting of goal oriented movements relating to a subject's eyes, head, neck, arms, hands, fingers and combinations thereof.

13. The method of claim 1, wherein the selected serial order of the alphabetic open-bigram set array provided in the ruler is selected from the group including: direct alphabetic open-bigram set array, inverse alphabetic open-bigram set array, direct type of alphabetic open-bigram set array, inverse type of alphabetic open-bigram set array, central type of alphabetic open-bigram set array, and inverse central type alphabetic open-bigram set array.

14. The method of claim 1, wherein the predetermined number of iterations ranges from 1-23 iterations.

15. The method of claim 1, wherein the sensory motor insertion of open-bigram terms is done by the subject by implementing a predefined selection choice method selected from the group including multiple-choice selection method, force choice selection method and go-no go selection method.

16. The method of claim 1, wherein the first predefined time interval is any time interval between 10 and 60 seconds and the one or more predefined time intervals of step e) are any time interval between 5 and 15 seconds.

17. A computer program product for promoting fluid intelligence abilities in a subject, stored on a non-transitory computer-readable medium which when executed causes a computer system to perform a method, comprising:
a) selecting a serial order of an alphabetic open-bigram set array from a predefined library of complete alphabetic open-bigram sequences, wherein the open-bigram terms all have the same spatial and time perceptual related attributes; and providing the subject with an incomplete serial order of alphabetic open-bigram terms, obtained by subtracting a predefined number of terms from selected ordinal positions of the selected set array, and a ruler containing the selected serial order of the alphabetic open-bigram set array;
b) within a first predefined time interval, prompting the subject to sensorially discriminate and sensory motor insert missing open-bigram terms selected from the ruler in the provided incomplete serial order of alphabetic open-bigram terms to form a completed serial order of alphabetic open-bigram terms from the selected set array;
c) if at least one open-bigram term sensory motor insertion made by the subject is incorrect, then returning to step b);
d) if the sensory motor insertions of all missing open-bigram terms obtained from the ruler made by the subject are all correct insertions, then displaying the correctly inserted open-bigram terms with at least one different spatial and/or time perceptual related attribute than the other open-bigram terms in the selected set array;
e) repeating the above steps for a predetermined number of iterations separated by one or more predefined time intervals; and
f) upon completion of the predetermined number of iterations, providing the subject with the results of each iteration.

18. A system for promoting fluid intelligence abilities in a subject, the system comprising:
a computer system comprising a processor, memory, and a graphical user interface (GUI), the processor containing instructions for:
a) selecting a serial order of an alphabetic open-bigram set array from a predefined library of complete alphabetic open-bigram sequences, wherein the open-bigram terms all have the same spatial and time perceptual related attributes; and providing the subject with an incomplete serial order of alphabetic open-bigram terms, obtained by subtracting a predefined number of terms from selected ordinal positions of the selected set array and a ruler containing the selected serial order of the alphabetic open-bigram set array on the GUI;
b) prompting the subject on the GUI to sensorially discriminate and sensory motor insert missing open-bigram terms obtained from the ruler in the incomplete serial order of alphabetic open-bigram terms, within a first predefined time interval, to form a completed serial order of alphabetic open-bigram terms from the selected set array;
c) if at least one open-bigram term sensory motor insertion made by the subject is incorrect, then returning to step b);
d) if the sensory motor insertions of all missing open-bigram terms obtained from the ruler made by the subject are all correct insertions, then displaying the correctly inserted open-bigram terms on the GUI with at least one different spatial and/or time perceptual related attribute than the other open-bigram terms in the selected set array;
e) repeating the above steps for a predetermined number of iterations separated by one or more predefined time intervals; and
f) upon completion of the predetermined number of iterations, providing the subject with the results of each iteration on the GUI.

19. A method of promoting fluid intelligence abilities in a subject comprising:
a) selecting a serial order of an alphabetic open-bigram set array with a predefined number of N open-bigram terms having the same spatial and time perceptual related attributes, from a predefined library of complete alphabetic open-bigram sequences; and selecting a plurality of incomplete alphabetic serial orders of consecutive open-bigram terms from the selected set array, each incomplete serial order having less terms than N open-bigram terms and following the same alphabetic serial order as the selected set array of N open-bigram terms;
b) providing the subject with one of the selected plurality of incomplete alphabetic serial orders of consecutive open-bigram terms and a ruler displaying the selected serial order of the alphabetic open-bigram set array of N open-bigram terms;
c) prompting the subject to sensorially discriminate and sensory motor select, within a first predefined time interval, two or more incomplete alphabetic serial orders of consecutive open-bigram terms remaining from the selected plurality of incomplete alphabetic serial orders of consecutive open-bigram terms, in order to contiguously complete the provided incomplete alphabetic serial order of consecutive open-bigram terms of step b) and form a completed serial order of alphabetic open-bigram terms from the selected set array of N open-bigram terms;
d) if at least one sensory motor selection of an incomplete alphabetic serial order of consecutive open-bigrams terms made by the subject is incorrect, then returning to step c);
e) if the two or more incomplete alphabetic serial orders of consecutive open-bigrams terms sensory motor selections made by the subject are all correct, then displaying the correctly selected incomplete alphabetic serial orders of consecutive open-bigram terms in the completed serial order of consecutive open-bigram terms with at least one different spatial and/or time perceptual related attribute than the provided incomplete alphabetic serial order of consecutive open-bigram terms of step b);
f) repeating the above steps for a predetermined number of iterations separated by one or more predefined time intervals; and
g) upon completion of the predetermined number of iterations, providing the subject with the results of each iteration.

20. The method of claim 19, wherein the selection of the set array of N open-bigram terms is done at random from the predefined library, and the further selection of the plurality of incomplete alphabetic serial orders of consecutive open-bigram terms is also done at random from a predefined number of open-bigram terms and predefined ordinal positions in the selected set array of N open-bigram terms.

21. The method of claim 19, wherein the predefined number of N open-bigram terms is an integer between 9 and 22.

22. The method of claim 19, wherein the predefined library of complete alphabetic open-bigram sequences comprises alphabetic open-bigram set arrays, wherein each member of a set array is a single different open-bigram term, comprising: direct alphabetic open-bigram set array, inverse alphabetic open-bigram set array, direct type of alphabetic open-bigram set array, inverse type of alphabetic open-bigram set array, central type of alphabetic open-bigram set array, and inverse central type alphabetic open-bigram set array.

23. The method of claim 22, wherein the selected set array of N open-bigram terms is selected from the group consisting of direct alphabetic open-bigram set array, direct type of alphabetic open-bigram set array, and central type of alphabetic open-bigram set array, and the one provided incomplete alphabetic serial order of consecutive open-bigram terms of step b) comprises 2-7 open-bigram terms.

24. The method of claim 23, wherein the one provided incomplete alphabetic serial order of consecutive open-bigram terms of step b) has between 3 and 5 open-bigram terms.

25. The method of claim 22, wherein the selected set array of N open-bigram terms is selected from the group consisting of inverse alphabetic open-bigram set array, inverse type of alphabetic open-bigram set array, and inverse central type of alphabetic open-bigram set array, and the one provided incomplete alphabetic serial order of consecutive open-bigram terms of step b) comprises 2-5 open-bigram terms.

26. The method of claim 25, wherein the one provided incomplete alphabetic serial order of consecutive open-bigram terms of step b) has 3 or 4 open-bigram terms.

27. The method of claim 19, wherein the plurality of incomplete alphabetic serial orders of consecutive open-bigram terms comprises 4-12 open-bigram sequences, each sequence comprising different open-bigram terms.

28. The method of claim 27, wherein the plurality of incomplete alphabetic serial orders of consecutive open-bigram terms has 6-10 open-bigram sequences, each sequence comprising different open-bigram terms.

29. The method of claim 19, wherein the plurality of incomplete alphabetic serial orders of consecutive open-bigram terms comprises 8-16 open-bigram sequences, each sequence comprising different open-bigram terms.

30. The method of claim 29, wherein the plurality of incomplete alphabetic serial orders of consecutive open-bigram terms has 10-12 open-bigram sequences, each sequence comprising different open-bigram terms.

31. The method of claim 19, wherein the at least one different spatial and/or time perceptual related attribute of step e) is selected from one or more spatial perceptual related attributes including: open-bigram term font size, open-bigram term font style, open-bigram term font spacing, open-bigram term font case, open-bigram term font boldness, open-bigram term font angle rotation, and open-bigram term font mirroring; and/or one or more time perceptual related attributes including: open-bigram term font color, intermittent display of an open-bigram term at a predefined frequency, and motion of an open-bigram term at a predefined speed across a visual field of the subject.

32. The method of claim 19, wherein the at least one different spatial and/or time perceptual related attribute of step e) is selected according to a predefined relationship between the spatial and/or time perceptual related attributes and an ordinal position of the open-bigram terms in the selected set array of N open-bigram terms.

33. The method of claim 32, wherein the at least one different spatial and/or time perceptual related attribute of open-bigram terms having an ordinal position falling in a left field of vision of the subject is different from the at least one different spatial and/or time perceptual related attribute of open-bigram terms having an ordinal position falling in a right field of vision of the subject.

34. The method of claim 19, wherein the sensorial discriminating and sensory motor selecting by the subject engages goal oriented motor activity within the subject's body, the goal oriented motor activity selected from the sensory motor group including: sensorial perception of the provided incomplete alphabetic serial order of consecutive open-bigram terms from step b); the sensorial discrimination and sensory motor selection of the two or more incomplete alphabetic serial orders of consecutive open-bigram terms in step c), goal oriented body movements involved in prompting the subject in step c), and combinations thereof.

35. The method of claim 34, wherein the goal oriented body movements are selected from the group consisting of goal oriented body movements of a subject's eyes, head, neck, arms, hands, fingers and combinations thereof.

36. The method of claim 19, wherein the serial order of the alphabetic open-bigram set array of N open-bigram terms shown in the ruler is selected from the group including: direct alphabetic open-bigram set array, inverse alphabetic open-bigram set array, direct type of alphabetic open-bigram set array, inverse type of alphabetic open-bigram set array, central type of alphabetic open-bigram set array, and inverse central type alphabetic open-bigram set array.

37. The method of claim 19, wherein the predetermined number of iterations ranges from 1-23 iterations.

38. The method of claim 19, wherein the formation of the completed serial order of alphabetic open-bigram terms from the selected set array of N open-bigram terms is accomplished by the subject by implementing a predefined sensory motor selection choice method selected from the group including: multiple-choice selection method, force choice selection method and go-no go selection method.

39. The method of claim 19, wherein the first predefined time interval is any time interval between 10 and 60 seconds and the one or more predefined time intervals of step f) are any time interval between 5 and 15 seconds.

40. A computer program product for promoting fluid intelligence abilities in a subject, stored on a non-transitory computer-readable medium which when executed causes a computer system to perform a method, comprising:
a) selecting a serial order of an alphabetic open-bigram set array with a predefined number of N open-bigram terms having the same spatial and time perceptual related attributes from a predefined library of complete alphabetic open-bigram sequences; and selecting a plurality of incomplete alphabetic serial orders of consecutive open-bigram terms from the selected set array, each incomplete serial order having less terms than N open-bigram terms and following the same alphabetic serial order as the selected set array of N open-bigram terms;
b) providing the subject with one of the selected plurality of incomplete alphabetic serial orders of consecutive open-bigram terms and a ruler displaying the selected serial order of the alphabetic open-bigram set array of N open-bigram terms;
c) prompting the subject to sensorially discriminate and sensory motor select, within a first predefined time interval, two or more incomplete alphabetic serial orders of consecutive open-bigram terms remaining from the selected plurality of incomplete alphabetic serial orders of consecutive open-bigram terms, in order to contiguously complete the provided incomplete alphabetic serial order of consecutive open-bigram terms of step b) and form a completed serial order of alphabetic open-bigram terms from the selected set array of N open-bigram terms;
d) if at least one sensory motor selection of an incomplete alphabetic serial order of consecutive open-bigram terms made by the subject is incorrect, then returning to step c);
e) if the two or more incomplete alphabetic serial orders of consecutive open-bigram terms sensory motor selections made by the subject are all correct, then displaying the correctly selected incomplete alphabetic serial orders of consecutive open-bigram terms in the completed serial order of consecutive open-bigram terms with at least one different spatial and/or time perceptual related attribute than the provided incomplete alphabetic serial order of consecutive open-bigram terms of step b);
f) repeating the above steps for a predetermined number of iterations separated by one or more predefined time intervals; and
g) upon completion of the predetermined number of iterations, providing the subject with the results of each iteration.

41. A system for promoting fluid intelligence abilities in a subject, the system comprising:
a computer system comprising a processor, memory, and a graphical user interface (GUI), the processor containing instructions for:
a) selecting a serial order of an alphabetic open-bigram set array with a predefined number of N open-bigram terms having the same spatial and time perceptual related attributes from a predefined library of complete alphabetic open-bigram sequences; and selecting a plurality of incomplete alphabetic serial orders of consecutive open-bigram terms from the selected set array, each incomplete serial order having less terms than N open-bigram terms and following the same alphabetic serial order as the selected set array of N open-bigram terms;
b) providing the subject on the GUI with one of the selected plurality of incomplete alphabetic serial orders of consecutive open-bigram terms and a ruler displaying the selected serial order of the alphabetic open-bigram set array of N open-bigram terms;
c) prompting the subject on the GUI to sensorially discriminate and sensory motor select, within a first predefined time interval, two or more incomplete alphabetic serial orders of consecutive open-bigram terms remaining from the selected plurality of incomplete alphabetic serial orders of consecutive open-bigram terms in order to contiguously complete the provided incomplete alphabetic serial order of consecutive open-bigram terms of step b) and form a completed serial order of alphabetic open-bigram terms from the selected set array of N open-bigram terms;
d) if at least one sensory motor selection of an incomplete alphabetic serial order of consecutive open-bigram terms made by the subject is incorrect, then returning to step c);
e) if the two or more incomplete alphabetic serial orders of consecutive open-bigram terms sensory motor selections made by the subject are all correct, then displaying the correctly selected incomplete alphabetic serial orders of consecutive open-bigram terms in the completed serial order of consecutive open-bigram terms on the GUI with at least one different spatial and/or time perceptual related attribute than the provided incomplete alphabetic serial order of consecutive open-bigram terms of step b);
f) repeating the above steps for a predetermined number of iterations separated by one or more predefined time intervals; and
g) upon completion of the predetermined number of iterations, providing the subject with the results of each iteration on the GUI.
